(19) United States
(12) Patent Application Publication
(10) Pub. No.: US 2025/0243310 A1
(43) Pub. Date: Jul. 31, 2025

(54) ANION EXCHANGE BRANCHED CO-POLYMER WITH POLY(ARYL) AND A BRANCHED COMPOUND AND QUINUCLIDINIUM SIDE CHAINS AND SYNTHESIS THEREOF

(71) Applicant: USA Fortescue IP, INC., Wilmington, DE (US)

(72) Inventors: Qiuying Zhang, Fairfax, VA (US); Mengjie Chen, Seaford, DE (US); Bamdad Bahar, Georgetown, DE (US); Sarah Toombs, Stafford, VA (US); Benjamin Kredensor, Fairfax, VA (US)

(21) Appl. No.: 19/183,650

(22) Filed: Apr. 18, 2025

Related U.S. Application Data
(63) Continuation-in-part of application No. 18/927,474, filed on Oct. 25, 2024, now Pat. No. 12,283,729.
Application No. 18/927,474 is a continuation of application No. PCT/US2024/024460, filed on Apr. 12, 2024.
(60) Provisional application No. 63/472,987, filed on Jun. 14, 2023.
(60) Provisional application No. 63/458,907, filed on Apr. 12, 2023.
(60) Provisional application No. 63/616,542, filed on Dec. 30, 2023.
(60) Provisional application No. 63/531,026, filed on Aug. 7, 2023.
(60) Provisional application No. 63/532,235, filed on Aug. 11, 2023.
(60) Provisional application No. 63/627,787, filed on Jan. 31, 2024.
(60) Provisional application No. 63/562,416, filed on Mar. 7, 2024.

(51) Int. Cl. C08G 10/00; B01J 41/05; B01J 41/14; B01J 47/12; C08J 5/22; H01M 8/10; H01M 8/1023; H01M 8/1039; H01M 8/1053; H01M 8/1081

(52) U.S. Cl. CPC C08G 10/00; B01J 41/05; B01J 41/14; B01J 47/12; C08J 5/2262; H01M 8/1023; H01M 8/1039; H01M 8/1053; H01M 8/1081; C08J 2361/18; H01M 2008/1095

(57) ABSTRACT

An anion exchange branched co-polymer includes poly(aryl) and a branched compound and quinuclininuium side chains. The co-polymer may include xanthene or bibenzofuran. The anion exchange branched co-polymer may be more durable and have less creep and may have a higher ion exchange capacity (IEC) due to the structure and because some of the side chains may have multiple functional sites. The co-polymer may be cross-linked and may also include free radical inhibitors. The co-polymer may be incorporated into a support material and used in an anion exchange membrane or membrane electrode assembly.

### CROSS REFERENCE TO RELATED APPLICATIONS

This application is a continuation in part of U.S. patent application Ser. No. 18/927,474, filed on Oct. 25, 2024 and currently pending, which is a continuation of PCT application No. PCT/US2024/024460, having an international filing date of Apr. 12, 2024, which claims the benefit of priority to U.S. provisional patent applications, No. 63/458,907, filed on Apr. 12, 2023, No. 63/459,184, filed on Apr. 13, 2023, No. 63/472,987, filed on Jun. 14, 2023, No.63/616,542, filed on Dec. 30, 2023, No. 63/531,026, filed on Aug. 7, 2023, No. 63/532,235, filed on Aug. 11, 2023, No. 63/627,787, filed on Jan. 31, 2024, and No. 63/562,416, filed on Mar. 7, 2024; the entirety of all prior applications is hereby incorporated by reference therein.

### BACKGROUND OF THE INVENTION

### Field of the Invention

This application is directed to the new anion exchange poly(phenylene) co-polymers integrated with n-methylquinuclidinium.

### Background

In recent years, proton exchange membrane fuel cells including solid polymer membrane as the electrolyte has been widely studied due to their high efficiency and density as well as low start temperature. However, the use of noble metal catalysts such as platinum has been an obstacle of viable commercialization of proton exchange membrane fuel cells. Also, high pH condition is a significant requirement for alkaline membrane fuel cells, which limits the utilization of proton exchange membrane. Therefore, the interest of developing anion exchange membranes (AEM) for alkaline fuel cells has prominently grown due to the low overpotentials caused by electrochemical reactions at alkaline environment and the dispensation of noble metal catalysts. A good anion exchange membrane for alkaline fuel cells should be with necessary conductivity, chemical and mechanical stability. Moreover, low cost is another significant requirement of developing new anion exchange membranes. For example, a well-known cation exchange membrane (Nafion) developed by DuPont contributes up to 40% of the total cost of some redox flow batteries. Hence, the high cost rendered people to seek more cheaper alternatives, primarily anion exchange membranes. Up to now, most commercially available anion exchange membranes are based on cross-linked polystyrene, which are not chemically stable in alkaline environments. Some other aryl ether-containing polymer backbones of anion exchange membranes tend to be attacked by hydroxide ions, which causes the degradation of the polymers. As a result, developing aryl ether-free polyphenylene-based ionomers employing stable cationic groups is a promising direction for anion exchange membrane (AEM) fuel cell. Poly(phenylene)s and their derivatives have received many attentions because of their good performance on thermal, mechanical, and electrochemical properties. However, the lower solubility of the growing rigid rod chains in the process of polymerization of poly(phenylene)s causes the low molecular weight. In order to overcome the issue, researchers tried to introduce pendent sidechains to the phenyl rings and successfully improved the solubility of poly(phenylene)s.

It should be noted that poly(phenylene)s is a kind of conjugated polymer which is promising in the application of biosensors research. To use those kind of polymer materials in biological applications, introducing appropriate sidechains to poly(phenylene) backbones and render them soluble in water and other polar solvents is critically necessary.

AEMs are generally made up of ionomers with pendant cationic groups such as benzyl trimethylammonium (BTMA) which is most commonly used, sulfonate and carboxylate etc. Hibbs et. al have applied BTMA cations for attaching to polymer backbones. Many BTMA-containing AEMs developed by them showed excellent properties and chemical stability. For example, the ion exchange capacity of a perfluorinated AEM with BTMA decreased less than 5% after 233-hour test at 50° C. Moreover, some BTMA-containing membranes can bear high temperature over 60° C. and keep chemical stability without thermal-degradation. Hence, the investigation and development of more chemically stable sidechains are becoming a considerable direction of enhancing anion exchange membrane (AEM) fuel cell.

### SUMMARY OF THE INVENTION

The polyphenylene-based co-polymers integrated with N-methylquinuclidiniumcation are presented in this embodiment. There are few approaches reported for carbon-carbon coupling polymerizations such as Suzuki and Yamamoto coupling, which are two of methods has been widely and successfully used to synthesize poly(phenylene)s, which is costly and strict to the environment of storing Palladium-containing catalysts. In this embodiment, we applied super-acid catalyzed Friedel-Crafts polycondensation for the synthesis of the polyphenylene-based co-polymer mixtures comprising:

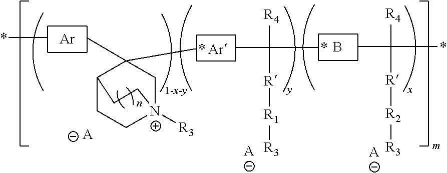

wherein:
Ar is selected from one of or multiple of the compounds from the group of aromatic compounds; Ar′ is selected from one of or multiple of the compounds from the group of aromatic compounds; B is selected from one of or multiple of the compounds from the group of branching agents; R′ is the same or different and independently of each other selected from the group consisting of hydrogen, alkyl, alkylene, cycloalkylene, arylene. X is the mole fraction of branching agent which is in the range of 0.001-1; y is in the range of 0-0.999, and 0.001≤x+y≤1.0; m is degree of polymerization which is in the range of 10-1000000. n is in the range of 0-10. R1, R2 are the same or different and independently of each other selected from the structures below and A⁻ is selected from halogen, hydroxide, or carbonate anions:

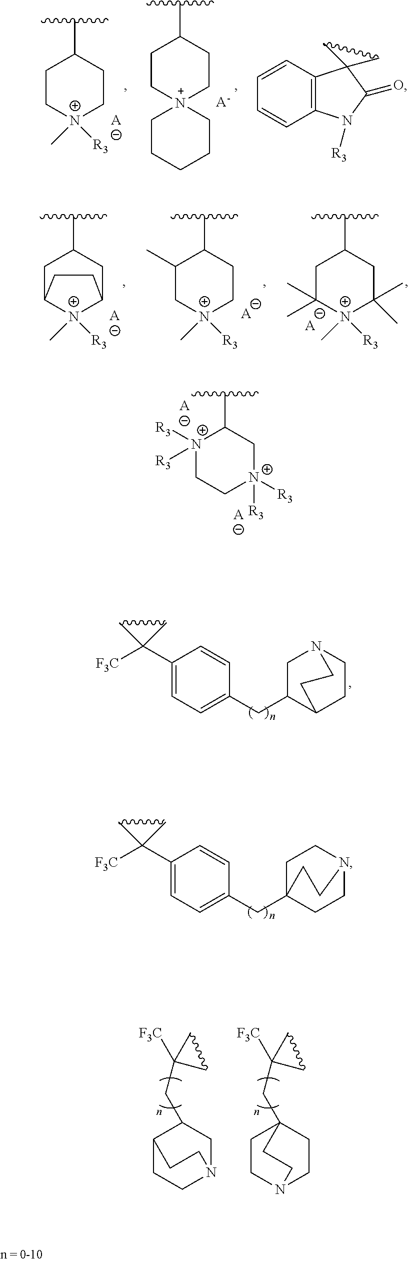

R3 is selected from the structures below and A is selected from halogen. hydroxide, or carbonate anions:

—(CH₂)ₙCH₃ (n=0-10);

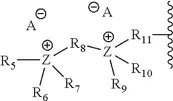

### Wherein:

R8 and R11 are each independently alkyl, alkylene, alkynyl, aryl
R5, R6, R7, R9, R10 are each independently alkyl, alkylene, alkynyl, aryl Z is N or P
For example a linear structure:

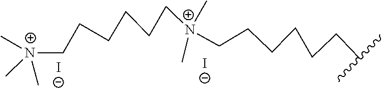 [SMILES: *CCCCCC[N+](C)(C)CCCCCC[N+](C)(C)C ; [I-] ; [I-]]

A cyclic structure

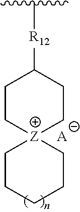

### Wherein

R12 is selected from alkyl, alkylene, alkynyl, aryl, prefer C1-C6
n=1-10
Z is selected from N or P
X is halogen such as I, Br, Cl

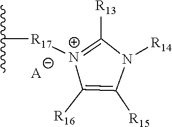

### Wherein

R13, R14, R15, R16, R17 are the same or independently selected from alkyl, alkylene, alkynyl, aryl
For example:

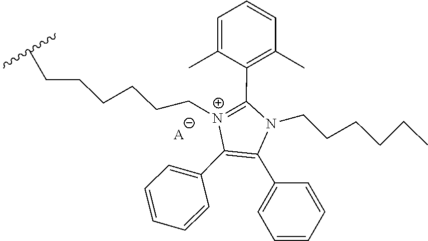

R4 is selected from CF3, proton
Ar is selected from one or multiple of the aromatic compounds having the structures below, including a polyxanthene as shown below:

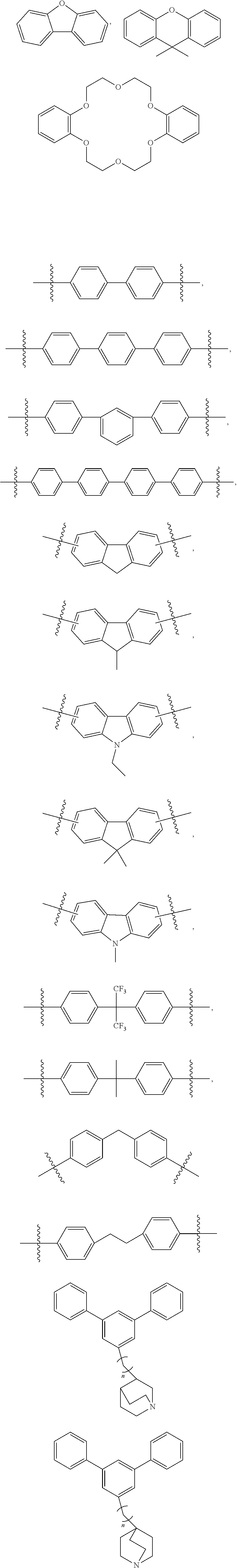

Ar′ is selected from one or multiple of the aromatic compounds from the group above or from the aromatic compounds containing quaternary ammonium salt cations and having the structures below:

### Wherein:

B is selected from one of or multiple of the compounds from the group below:

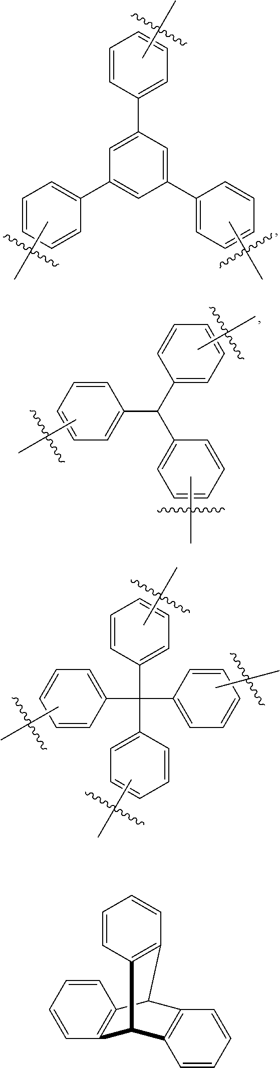

The co-polymers integrated with quinuclidinium-based cation are presented in this embodiment. There are few approaches such as Suzuki and Yamamoto coupling reported for carbon-carbon coupling polymerizations, which are two methods used to synthesize the co-polymer in this embodiment. We applied coupling polymerization methods for the synthesis of the co-polymer mixtures comprising:

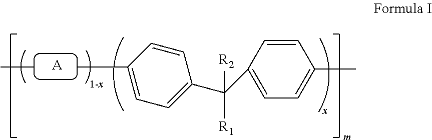

A method of synthesizing the co-polymers shown above is through Yamamoto-coupling homo-polymerization which comprises those reacting monomers selected from

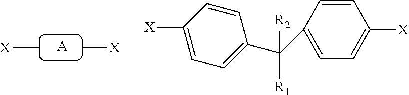

### X═Cl, Br

The reaction equation is shown below:

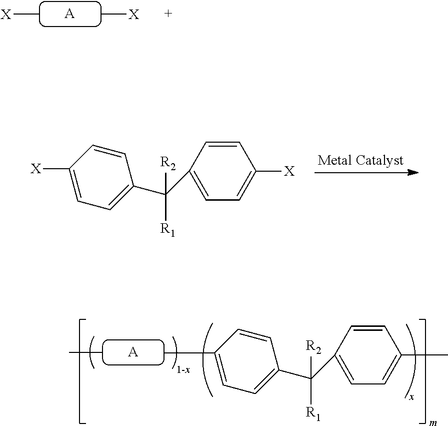

A method of synthesizing the co-polymers shown above are through polycondensation under the catalysis of one or both of strong acids such as trifluoromethanesulfonic acid (TFSA) and trifluoroacetic acid (TFA), which comprises those reacting monomers selected from Ar, Ar′ and B as well as quinuclidinium derivative, trifluoroalkyl ketone derivatives. The reaction equation is shown below:

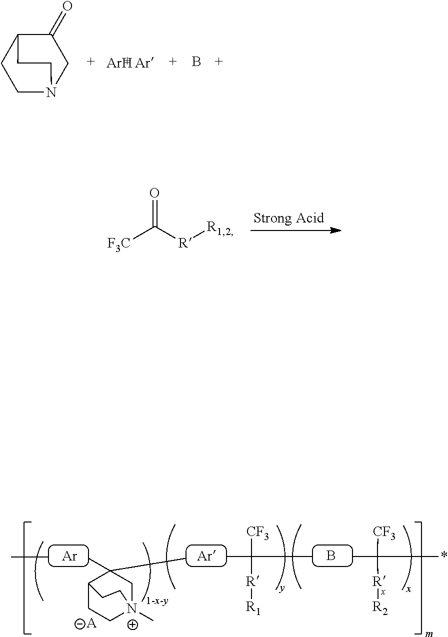

A branching compound enables higher entanglement of the polymer to prevent slipping and creep and overall mechanical properties including toughness and higher modulus. Also, a branching compound may enable high IEC as the functional sites may be configured more closely together. Also, the polymer as described herein may include multiple functional groups per side chain that can increase IEC.

Either dibenzofuran or xanthene are hydrophilic unit which is beneficial for phase separation morphology and subsequently increases conductivity.

The present invention provides two mechanically reinforced anion exchange membranes comprising a functional polymer based on polyxanthene backbone and poly(fluorene-aryl) co-backbone respectively with quaternary ammonium functional groups and an inert porous scaffold material for reinforcement. Typically, the anion exchange membrane is prepared by imbibing the porous scaffold material with a polymer solution of a non-ionic precursor polymer followed by conversion of a functional moiety on the polymer to form a trimethyl ammonium cation. Such a conversion can be accomplished by treatment of the precursor polymer membrane with trimethylamine. In addition, an optional chemical crosslinking reaction can also be used to toughen the polymer by converting it from a thermoplastic to a thermoset material. Such a conversion can be accomplished by treatment of the precursor polymer membrane by a diamine, which is typically performed before the amination reaction. Typically, the thickness of the functionalized membrane is 25 micrometers or less, more typically 10 micrometers or less, and in some embodiments 5 micrometers or less.

Exemplary polyxanthene-based and a poly(fluorene-aryl) based polymers may have functional groups selected from the group of quaternary ammoniums, tertiary diamines, phosphonium, benz (imidazolium), sulphonium, guanidinium, metal cations, pyridinium. Preferably the functional group is quaternary ammonium

An ion exchange polymer may be improved by the incorporation of polyxanthene as it is increases conductivity because it includes hydrocarbons that make the polymer more hydrophilic and enables good phase separation in the anion exchange membrane. Then integrate polyxanthene as one component. Polyxanthene is more rigid than a linear polymer such as polyphylene which may aid in the formation of nano-channels for ion transport.

An exemplary porous scaffold support is made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

Exemplary polyxanthene-based and a poly(fluroene-aryl)-based polymers may have additive selected from a group consisting of radical scavengers, plasticizers, fillers, anion conducting material, crosslinking agent.

The polyxanthene-based polymer comprises 9H-xanthene with twisted structure and trifluoroalkyl side chains. In this embodiment, we applied super-acid catalyzed Friedel-Crafts polycondensation for the synthesis of polyxanthene-based AEM polymer comprising:
(i) polyxanthene backbone and trifluoroalkyl side chains having halogen active sites which can be functionalized by quaternary ammonium (QA) functional groups (1):

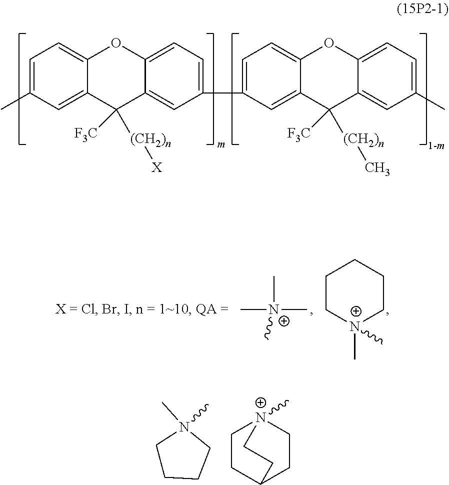

The poly(fluorene-aryl) polymer comprises 9H-xanthene with twisted structure and trifluoroalkyl side chains. In this embodiment, we applied super-acid catalyzed Friedel-Crafts polycondensation for the synthesis of polyxanthene-based AEM polymer comprising
(i) poly(fluorene-aryl) backbone and alkylated phenyl side chains having halogen active sites which can be functionalized by quaternary ammonium (QA) functional groups (2):

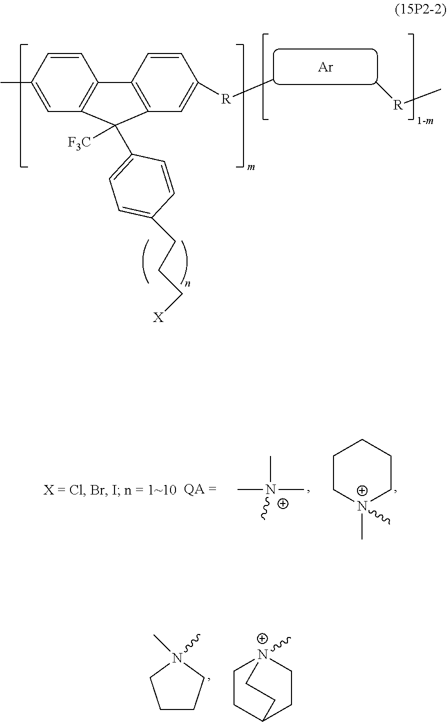

(ii) an Ar monomer having one or two of the structures below:

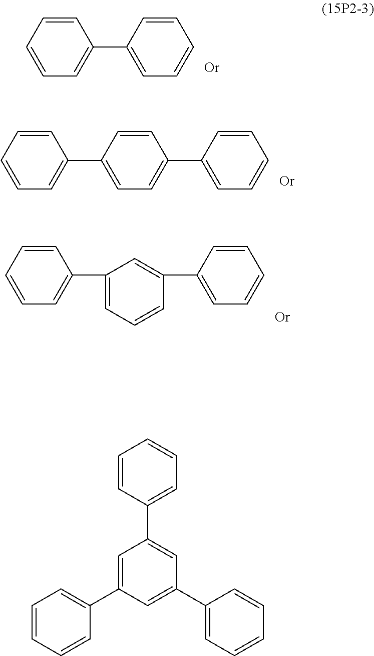

(iii) an R linker having one of the structures below:

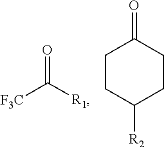

Wherein:
R1 is selected from the alkyl, aryl, R2 is selected from hydrogen, alkyl, aryl.

The two hydroxide exchange co-polymers are synthesized which comprises ether free poly(fluorene-aryl) and polyxanthene backbones integrated with functionalized spacer. The water uptake, IEC and conductivity were measured accordingly.

A method of synthesizing the hydroxide exchange co-polymers shown in Formula (15P2-1) and (15P2-2) is described below, which comprises that reacting monomers shown in either Formula (15P2-1) or (15P2-2) in organic solvent with super acid catalyst to form neutral intermediate polymers; quaternization of the neutral intermediate polymer in organic solvent to form ionic polymer; dissolvent the ionic polymer in organic solvent for solution-casting membranes; the membrane is immersed in base solution for ion exchange to form hydroxide exchange membrane.

A method of casting the anion exchange co-polymers shown above are described below, which comprises dissolving the co-polymers in one or multiple of organic solvents such as DMSO, NMP, DMAc, DMF and pouring and casting membranes on reinforced materials with different thicknesses. After evaporating organic solvents, the anion exchange membranes containing above polymer structures are obtained, the anion is halogen before converting to the other anions as such hydroxide, carbonate, bicarbonate, sulfate, phosphoric ion pairs.

An exemplary process for casting or making a composite anion exchange membrane includes combining a support layer solvent with an exchange polymer solvent to produce a solvent mixture. The support layer solvent may be an alcohol or solvent that is configured to wet the surface of a hydrocarbon polymer such as polypropylene or polyethylene. The exchange polymer solvent is configured to wet the anion exchange polymer and enable the polymer to form a solution or dissolve in the solvent. The anion exchange polymer is mixed with the solvent mixture and the combined with a support material, wherein this polymer solution wets the pores of the support layer and when the solvent is evaporated, leaves the anion exchange polymer in the pores to create a composite anion exchange membrane.

The reinforced materials are selected from Polytetrafluoroethylene (PTFE), expanded Polytetrafluoroethylene (ePTFE), polyethylene (PE), Polyether ether ketone (PEEK), Polyethylene terephthalate (PET)

The thickness of the reinforced anion exchange membrane is in the range 0.001-5 mm with a preferred being less than 200 μm, more preferred less than 100 μm and even more preferred less than 50 μm. The porous scaffold may be a microporous scaffold having an average or mean flow pore size of less than 1 micron as determined by a Capillary Flow Porometer, available from Porous Materials, Inc. Ithaca, NY, and the mean flow pore size may be about 0.5 microns or less, or even about 0.25 microns or less. A porous scaffold may be a porous fluoropolymer, such as expanded polytetrafluoroethylene or a porous olefin, such as a porous polyethylene and the like.

The thickness of the composite anion conductive membrane including an anion conductive polymer, as described herein, imbibe or coated onto a porous scaffold, may be about 50 microns or less, about 25 microns or less, about 15 microns or less, about 10 microns or less or even about 5 microns or less. The thinner the composite, the higher the rate ionic conductivity.

The present invention provides two mechanically reinforced anion exchange membranes comprising a functional polymer based on polyxanthene backbone with quaternary ammonium functional groups and an inert porous scaffold material for reinforcement. Typically, the anion exchange membrane is prepared by imbibing the porous scaffold material with a polymer solution of a non-ionic precursor polymer followed by conversion of a functional moiety on the polymer to form a trimethyl ammonium cation. Such a conversion can be accomplished by treatment of the precursor polymer membrane with trimethylamine. In addition, an optional chemical crosslinking reaction can also be used to toughen the polymer by converting it from a thermoplastic to a thermoset material. Such a conversion can be accomplished by treatment of the precursor polymer membrane by a diamine, which is typically performed before the amination reaction. Typically, the thickness of the functionalized membrane is 25 micrometers or less, more typically 10 micrometers or less, and in some embodiments 5 micrometers or less.

Exemplary polyxanthene-based polymers may have functional groups selected from the group of quaternary ammoniums, tertiary diamines, phosphonium, benz (imidazolium), sulphonium, guanidinium, metal cations, pyridinium. Preferably the functional group is quaternary ammonium.

An exemplary porous scaffold support is made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

Exemplary polyxanthene-based polymers may have additive selected from a group consisting of radical scavengers, plasticizers, fillers, anion conducting material, crosslinking agent.

The polyxanthene-based polymer comprises 9H-xanthene with planar backbone structure and trifluoroalkyl, N-heterocyclic side chains. In this embodiment, we applied super-acid catalyzed Friedel-Crafts polycondensation for the synthesis of polyxanthene-based AEM polymer comprising:
(iv) polyxanthene backbone and trifluoroalkyl side chains having halogen active sites which can be functionalized by quaternary ammonium (QA) functional groups (1):

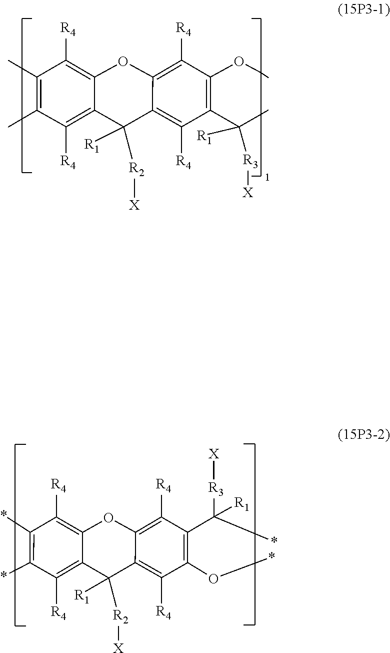

R1 is independently selected from haloalkane, Hydrogen, alkyl; R2 is independently selected from aryl, alkyl, aryl-alkane, n-heterocyclic alkyl; R3 is independently selected from aryl, alkyl, aryl-alkane, n-heterocyclic alkyl; R4 is independently selected from hydrogen, alkyl, aryl.

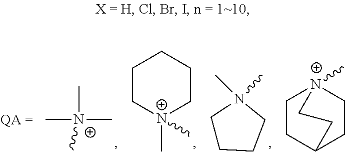

The polyxanthene-based polymer comprises 9H-xanthene with planar backbone structure and trifluoroalkyl, wherein the planar backbone is defined by pi interactions, such that it can not be twisted or rotated.

The poly(alkyl-xanthene) polymer comprises 9H-xanthene with twisted structure and trifluoroalkyl side chains. In this embodiment, we applied super-acid catalyzed Friedel-Crafts polycondensation for the synthesis of polyxanthene-based AEM polymer comprising
(ii) poly(alkyl-xanthene) backbone and alkylated phenyl side chains having halogen active sites which can be functionalized by quaternary ammonium (QA) functional groups (15P3-2):

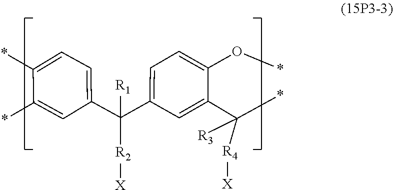

R1 is independently selected from haloalkane, Hydrogen, alkyl; R2 is independently selected from aryl, alkyl, aryl-alkane, N-heterocyclic alkane; R3 is independently selected from haloalkane, Hydrogen, alkyl; R4 is independently selected from aryl, alkyl, aryl-alkane, N-heterocyclic alkane; X is independently selected from H, Cl, Br

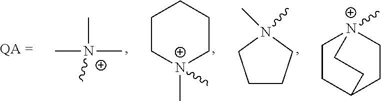

The two hydroxide exchange co-polymers are synthesized which comprises ether free polyxanthene and poly(alkyl-xanthene) backbones integrated with functionalized spacer. The water uptake, IEC and conductivity were measured accordingly.

A method of synthesizing the hydroxide exchange co-polymers shown in Formula (15P3-1) and (15P3-2) and (15P3-3) is described below with acid catalyst to form neutral intermediate polymers; quaternization of the neutral intermediate polymer in organic solvent to form ionic polymer; dissolvent the ionic polymer in organic solvent for solution-casting membranes; the membrane is immersed in base solution for ion exchange to form hydroxide exchange membrane. The acid is independently selected from hydrochloride acid, sulfuric acid, triflic acid, trifluoracetic acid.

The porous scaffold may be a microporous scaffold having an average or mean flow pore size of less than 1 micron as determined by a Capillary Flow Porometer, available from Porous Materials, Inc. Ithaca, NY, and the mean flow pore size may be about 0.5 microns or less, or even about 0.25 microns or less. A porous scaffold may

be a porous fluoropolymer, such as expanded polytetrafluoroethylene or a porous olefin, such as a porous polyethylene and the like.

The thickness of the composite anion conductive membrane including an anion conductive polymer, as described herein, imbibe, or coated onto a porous scaffold, may be about 50 microns or less, about 25 microns or less, about 15 microns or less, about 10 microns or less or even about 5 microns or less. The thinner the composite, the higher the rate ionic conductivity.

This application incorporates by reference, U.S. provisional patent application No. 63/196,671, filed on Jun. 3, 2021, U.S. provisional patent application No. 63/278,780, filed on Nov. 12, 2021, U.S. provisional patent application No. 63/274,702 filed on Nov. 2, 2021; U.S. provisional patent No. 63/451,555, filed on Mar. 11, 2023, and U.S. provisional patent No. 63/472,987, filed on Jun. 14, 2023; the entirety all prior applications are hereby incorporated by reference herein.

The present invention provides a mechanically reinforced phosphoric acid doped ion pair ion exchange membrane comprising a functional polymer based on a poly(phenylene) backbone with quaternary ammonium and N-Methylpiperidine-based functional groups and an inert porous scaffold material for reinforcement. Typically, the starting anion exchange membrane is prepared by imbibing the porous scaffold material with a polymer solution of a non-ionic precursor polymer followed by conversion of a functional moiety on the polymer to form a trimethyl ammonium cation. Such a conversion can be accomplished by treatment of the precursor polymer membrane with trimethylamine. The phosphoric acid doping process was conducted in phosphoric acid bath. Typically, the thickness of the functionalized membrane is 25 micrometers or less, more typically 10 micrometers or less, and in some embodiments 5 micrometers or less.

Exemplary poly(phenylene) may have functional groups selected from the group of quaternary ammoniums, tertiary diamines, phosphonium, benz (imidazolium), sulphonium, guanidinium, metal cations, pyridinium. Preferably the functional group is quaternary ammonium.

An exemplary porous scaffold support is made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

Exemplary polyphenylene may have additive selected from a group consisting of radical scavengers, plasticizers, fillers, anion conducting material, crosslinking agent.

The polyphenylene co-polymers comprises 9,9-Dimethylxanthene with twisted structure and the derivative of alkane in which one phenyl group is bonded to each carbon atom are presented in this embodiment. There are few approaches reported for carbon-carbon coupling polymerizations such as Suzuki and Yamamoto coupling, which are two of methods has been widely and successfully used to synthesize poly(phenylene)s, which is costly and strict to the environment of storing Palladium-containing catalysts. In this embodiment, we applied super-acid catalyzed Friedel-Crafts polycondensation for the synthesis of the co-polymer mixtures comprising:
Either A trifluoro-based and isatin-based spacer having the precursor chemical structures (20P-1) and (20P-2):

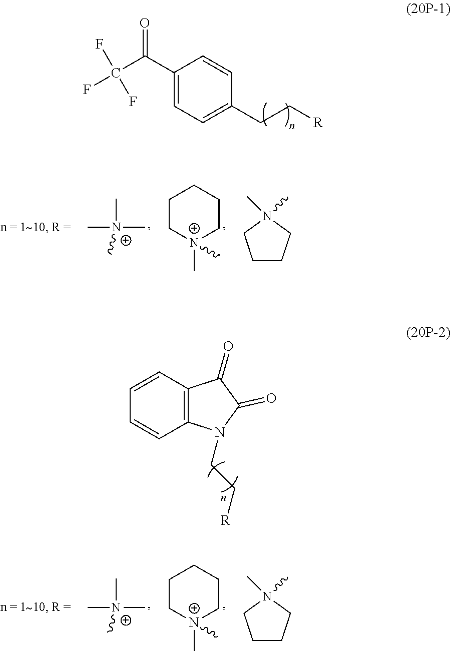

an aromatic monomer having the structure (20P-3):

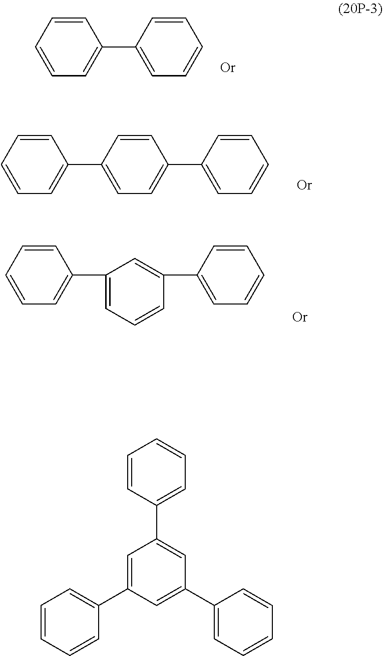

a derivative of alkane having the structure (20P-4)

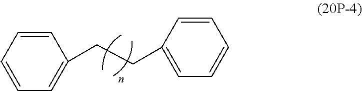 [SMILES: c1ccc(CCc2ccccc2)cc1]

### Wherein:

n is in the range of 1-10
   a fluorene-based structure having the structure (20P-5)

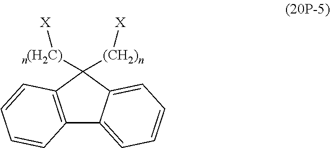

Wherein:
   n=1˜10, X═Cl, Br, I
      The anion exchange co-polymers having the formula (20P-1):

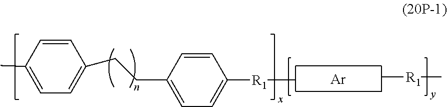

### Wherein:

R1 is selected from the anyone from structure (20P-1) or (20P-2)
   The anion exchange co-polymers having the formula (20P-2):

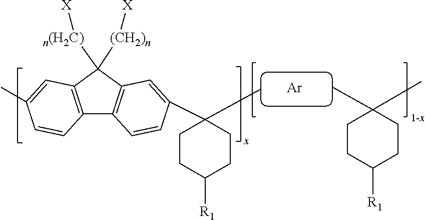

The starting anion exchange co-polymers are synthesized which comprises ether free polyphenylene backbones integrated with functionalized spacer. The water uptake, IEC and conductivity were measured accordingly

A method of synthesizing the hydroxide exchange co-polymers shown in Formula (1) & (2) is described below, which comprises that reacting monomers shown in Formula (1) in organic solvent with super acid catalyst to form neutral intermediate polymers; quaternization of the neutral intermediate polymer in organic solvent to form ionic polymer; dissolvent the ionic polymer in organic solvent for solution-casting membranes; the membrane is immersed in base solution for ion exchange to form hydroxide exchange membrane.

The present invention provides a mechanically reinforced phosphonate-based ion pair exchange membrane comprising a functional co-polymer based on a poly(phenylene) backbone and an inert porous scaffold material for reinforcement. Typically, the starting co-polymer is prepared by imbibing the porous scaffold material with a polymer solution of a non-ionic precursor polymer followed by conversion of a functional moiety on the polymer to form phosphonate group. Such a conversion can be accomplished by treatment of the starting co-polymer membrane with Michaelis-Arbuzov reaction. Typically, the thickness of the functionalized membrane is 25 micrometers or less, more typically 10 micrometers or less, and in some embodiments 5 micrometers or less.

An exemplary porous scaffold support is made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

Exemplary polyphenylene may have additive selected from a group consisting of radical scavengers, plasticizers, fillers, anion conducting material, crosslinking agent.

The polyphenylene co-polymers comprises aromatic compounds, fluorenes, and the derivative of alkane in which one phenyl group is bonded to each carbon atom are presented in this embodiment. There are few approaches reported for carbon-carbon coupling polymerizations such as Suzuki and Yamamoto coupling, which are two of methods has been widely and successfully used to synthesize poly(phenylene)s, which is costly and strict to the environment of storing Palladium-containing catalysts. In this embodiment, we applied super-acid catalyzed Friedel-Crafts polycondensation for the synthesis of the co-polymer mixtures comprising:
trifluoro-based spacer having the precursor chemical structures (24P-1) and (24P-2):

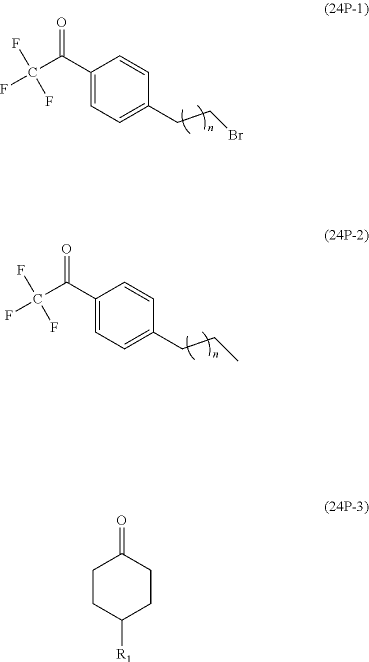

Wherein R1=H, alkyl, aryl
an aromatic monomer having the structure (24P-3):

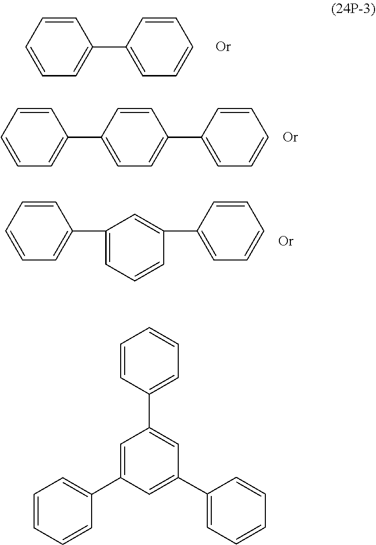

a derivative of alkane having the structure (24P-4)

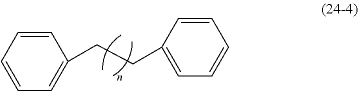 [SMILES: c1ccc(CCc2ccccc2)cc1]

### Wherein:

n is in the range of 1-10
a fluorene-based derivative having the structure (24P-5)

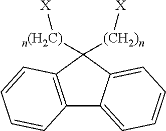

Wherein: n is in the range of 1-10, X═Cl, Br, I
The anion exchange co-polymers having the formula (24P-1) and (24P-2):

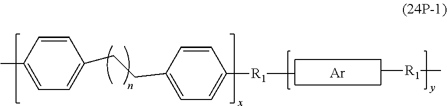

(24P-1)
Wherein R1 is selected from the anyone from the structure (1) & (2), the ratio between the structure (1) and (2) is in the range of 1:0-1

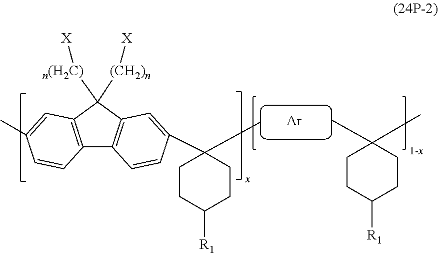

and
wherein R1=H, alkyl, aryl.

The starting co-polymers are synthesized which comprises ether free polyphenylene backbones integrated with functionalized spacer. The water uptake, IEC and conductivity were measured accordingly

A method of synthesizing the starting co-polymers shown in Formula (24P-1) is described below, which comprises that reacting monomers shown in Formula (24P-1) in organic solvent with super acid catalyst to form neutral intermediate polymers; phosphorylation of the neutral intermediate polymer in organic solvent to form ionic polymer; dissolvent the ionic polymer in organic solvent for solution-casting membranes;

The porous scaffold may be a microporous scaffold having an average or mean flow pore size of less than 1 micron as determined by a Capillary Flow Porometer, available from Porous Materials, Inc. Ithaca, NY, and the mean flow pore size may be about 0.5 microns or less, or even about 0.25 microns or less. A porous scaffold may be a porous fluoropolymer, such as expanded polytetrafluoroethylene or a porous olefin, such as a porous polyethylene and the like.

The thickness of the composite anion conductive membrane including an anion conductive polymer, as described herein, imbibed or coated onto a porous scaffold, may be about 50 microns or less, about 25 microns or less, about 15 microns or less, about 10 microns or less or even about 5 microns or less. The thinner the composite, the higher the rate ionic conductivity.

A process or method of making a composite anion exchange membrane includes combining an anion exchange polymer, as described herein, with a support layer. The method of making the composite anion exchange membrane may comprise the steps of: providing the anion conducting co-polymer; providing a support layer having pores; providing an exchange polymer solvent; providing a support layer solvent; mixing the exchange polymer solvent and support layer solvent to produce a solvent mixture; combining the solvent mixture with the anion conducting co-polymer to produce a polymer solution; combining the polymer solution with the support layer such that the polymer solution enters into the pores of said support layer, wherein the support layer solvent wets the support layer surface; and evaporating the support layer solvent and exchange polymer solvent to produce said composite anion exchange membrane wherein the anion exchange polymer extends through the pores from a first side to an opposing second side of the support layer. A pressure may be applied to the membrane and the polymer solution to force the polymer solution into and through the pores of the support layer and the pressure may be about 0.7 kPa or more, or from about 0.7 kPa to about 1378 kPa or about 500 kPa or more, about 1,000 kPa or more, or from about 500 kPa to about 1500 kPa. The support layer may hydrocarbon support layer being made of a hydrocarbon polymer, or may be a fluoropolymer support layer being made of a fluoropolymer. A support layer may be made of polyetheretherketone support layer.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows cross-sectional view of an exemplary anion exchange membrane comprising a thin sheet, less than 200 μm thick of anion exchange polymer.

FIG. 2 shows cross-sectional view of an exemplary porous reinforced support having a porous structure and pores therein, wherein the anion exchange polymer substantially fills the pores of the scaffold support.

FIG. 3 shows a cross-sectional view of an exemplary ultra-thin composite anion exchange polymer film having a layer of anion exchange polymer on either side of the porous reinforced support.

FIG. 4 shows cross-sectional view of an exemplary ultra-thin composite anion exchange polymer film formed by imbibing anion exchange polymer copolymer into a porous reinforced support using solution casting process, wherein the anion exchange polymer substantially fills the pores of the reinforced support.

FIG. 5 shows cross-sectional view of an exemplary membrane electrode assembly comprising a composite anion exchange membrane with a cathode on a first side and a anode on a second side.

FIG. 6 shows the polymer structure of polyxanthene.

FIG. 7 shows the polymer structure of poly(fluorene-aryl).

FIG. 8 shows the polymer structure of polyxanthene.

FIG. 9 shows the polymer structure of poly(fluorene-aryl).

FIG. 10 shows a polymer diagram for polyphenylene wherein Ar is the polyphenylene component, R1 is the spacer which can be functionalized and R is the functional group which can be ion paired with phosphoric acid.

FIG. 11 shows a cross sectional view of an exemplary porous scaffold reinforcement material employed in the present invention.

FIG. 12 shows a cross sectional view of an exemplary precursor polymer membrane formed from imbibing a precursor polymer into a porous scaffold reinforcement material.

FIG. 13 shows a cross sectional view of an exemplary anion exchange membrane formed from treating the precursor polymer membrane of FIG. 2 with trimethylamine.

FIG. 14 shows a polymer diagram for polyphenylene wherein Ar is the

polyphenylene component, 24P-R1 is one of the spacers selected from Structure (24P-1) and (24P-2)) which can be phosphorylated.

FIG. 15 is the synthetic pathways for the starting co-polymer shown in formula 1.

FIG. 16 is the chemical structure of target phosphonate-based ion pair exchange membrane.

FIG. 17 is the synthetic pathways for phosphorylation of the starting co-polymer.

FIG. 18 shows a polymer diagram for fluorene-based polyphenylene wherein Ar is the polyphenylene component, R1=H, alkyl, aryl.

FIG. 19 is the synthetic pathways for the starting co-polymer shown in formula 24P-2.

FIG. 20 is the chemical structure of covalently phosphoric acid doping polymer based on the structure of formula.

FIG. 21 is the synthetic pathways for phosphorylation of the polymer shown in formula.

FIG. 22 shows the synthetic routes of making quinuclidinium-based side chains.

FIG. 23 shows the synthetic routes of making quinuclidinium-based side chain.

FIG. 24 shows the synthetic routes of making Poly(imidazolium-co-arylquinuclidinium).

FIG. 25 shows the synthetic routes of making Poly(phenylene-co-arylquinuclidinium).

FIG. 26 shows a generally synthetic pathway for making in-situ crosslinked poly(aryl-co-aryl quinuclidinium) shown in Formula 36-I.

FIG. 27 shows a generally synthetic pathway for making in-situ crosslinked poly(aryl-co-aryl quinuclidinium) shown in Formula 36-II.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be an included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations, and improvements of the described embodiments, will occur to those skilled in the art and all such alternate embodiments, combinations, modifications, improvements are within the scope of the present invention.

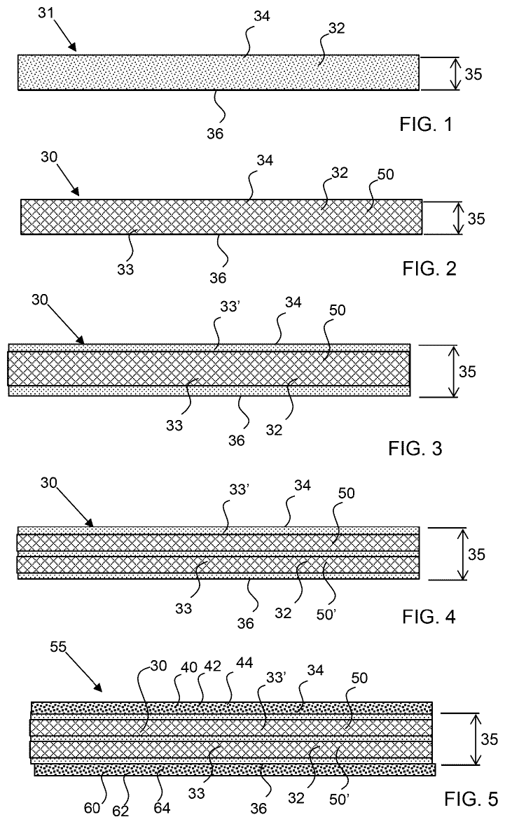

As shown in FIG. 1, an anion exchange membrane 31 is a planar thin layer of anion exchange polymer 32 having a planar first side 34 and second side 36, wherein the first side and second side extend in parallel to produce a substantially uniform thickness of the anion exchange membrane, with variations in thickness of no more than about 35% and preferably no more than 25% or even 10%.

As shown in FIG. 2, the anion exchange polymer 32 may be configured in a composite anion exchange membrane 30 has a support layer 33 and with anion exchange polymer 32 extending through the pores 50 from a first side 34 or anode side, to a second side 36 or cathode side. The thickness 35 of the composite anion exchange membrane 30 may be about 200 μm or less, about 150 μm or less, about 100 μm or less, about 50 μm or less, about 30 μm or less, about 25 μm or less, about 15 μm or less, about 10 μm or less, or even 5 μm or less.

As shown in FIG. 3, a composite anion exchange membrane 30 has a support layer 33 with anion exchange polymer 32 extending through the pores 50 of the support layer from a first side to a second side 36 of the support layer. Also, there is a layer of anion exchange polymer extending on the anode and cathode side, or first 34 and opposing second side of the composite anion exchange membrane 30. The thickness 35 of the composite anion exchange membrane 30 may be 50 μm or less, about 30 μm or less, about 25 μm or less, about 15 μm or less, about 10 μm or less, or even 5 μm or less. The proton exchange polymer 32 may be configured on just one side of a support layer 33, or may be only with the support layer or on one side and within at least partially the support layer.

As shown in FIG. 4, a composite anion exchange membrane 30 has a plurality of support layers 33 and 33′ and with anion exchange polymer 32 extending through the pores 50, 50′ of each layer from a first side to a second side 36 of each support layer. Also, there is a layer of anion exchange polymer extending on the anode and cathode side, or first 34 and opposing second side of the composite anion exchange membrane 30. The thickness 35 of the composite anion exchange membrane 30 may be 50 μm or less, about 30 μm or less, about 25 μm or less, about 15 μm or less, about 10 μm or less, or even 5 μm or less.

As shown in FIG. 5, the composite anion exchange membrane 30 may be incorporated into a membrane electrode assembly 55, having an anode 40 and cathode 60 on an opposing side of the composite anion exchange membrane 30. The anode may comprise an anode catalyst 42 and may also include an anode anion exchange polymer 44, which may be the same or different from the anion exchange polymer in the composite anion exchange membrane 30 or anion exchange membrane. Likewise, the cathode may comprise a cathode catalyst 62 and may also include an anode anion exchange polymer 64, which may be the same or different from the anion exchange polymer in the composite anion exchange membrane 30 or anion exchange membrane.

According to one embodiment, a synthetic route and a composition are disclosed. The composition includes one compound with poly(phenylene) backbones. The backbone of the polymer structure shown below consists of aryl rings, wherein one of the aryl rings links to a sidechain at para-position including a trifluoromethyl-based spacers and N-methylquinuclidiniumquaternary functional group.

Details of a process for synthesizing the anion conductive polymer and casting anion exchange membrane are presented in Example 1.

### Example 1

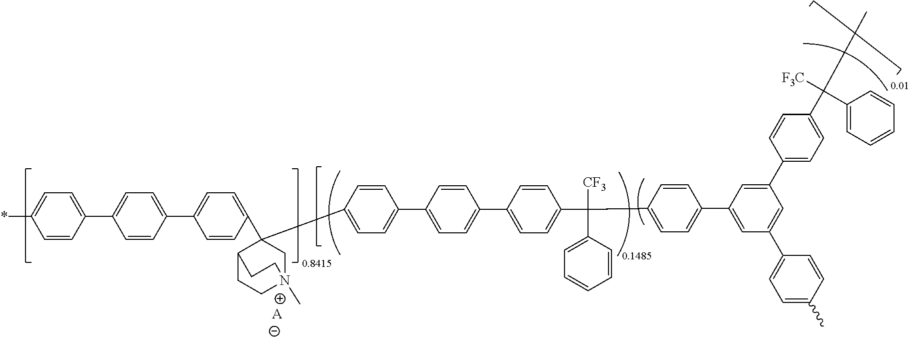

The polymer was synthesized via super-acid catalyzed polycondensation, which compromises that homogeneously mixing p-terphenyl (0.69 g, 3.0 mmol), 1-Azabicyclo[2.2.2]octan-3-one in chloride form (0.45 g, 2.78 mmol), 2,2,2-Trifluoro-1-phenylethanone (0.09 g, 0.52 mmol) and 1,3,5-triphenylbenzene (9.2 mg, 0.03 mmol) in dichloromethane, then the mixture was stirred at room temperature for 24 hours under the catalysis of TFAS. The resulting gel-like mixture was diluted with DMSO and poured into isopropanol to obtain white fiber-like polymer before washing the product with diethyl ether and drying under vacuum overnight.

The quaternization for obtaining final anion exchange polymer was carried out through mixing 1 equivalent of the polymer obtained above, 3 equivalent K₂CO₃, 5 equivalent iodomethane in 10 ml DMSO and stirring for 48 hours under dark environment before pouring the resulting mixture to isopropanol to obtain final anion conductive polymer.

The anion exchange membrane was prepared by dissolving the anion conductive polymer in DMSO to form 5 wt % solution, and then cast membranes on reinforced scaffold porous support material using doctor blade. The resulting membranes were immersed in 1M KBr solution for a week to fully convert to bromine form after completely evaporating DMSO. As needed, the anion exchange membranes can be converted to hydroxide form by immersing in NaOH solution for 3-4 days under inert atmosphere.

The precursor polymer solution was then applied to a microporous polyethylene material tensioned around a chemically resistant plastic frame. The polymer solution was then poured on to the microporous scaffold. The frame was covered with a lid to slow solvent evaporation. The membrane was dried at room temperature. The final thickness of the precursor membrane was 5 micrometers.

The precursor polymer was then applied to a microporous polyethylene or poly(tetrafluoroethylene) material with a doctor blade. The precursor polymer membrane was covered with a lid to slow solvent evaporation. The membrane was dried at room temperature. The final thickness of the membrane was 5-50 microns.

In one embodiment, a precursor membrane with formula (15P2-2) is prepared by dissolving the precursor polymer in a non-polar solvent such as chloroform, dichloromethane, tetrahydrofuran and toluene at a 1%-10% weight percent i.e. 0.25 grams of polymer dissolved in 2.25 g of solvent for a 10% solution. The mixture was stirred until homogenous and translucent.

The precursor polymer solution was then applied to a microporous polyethylene or poly(tetrafluoroethylene) material tensioned around a chemically resistant plastic frame. The polymer solution was then poured on to the microporous scaffold. The frame was covered with a lid to slow solvent evaporation. The membrane was dried at room temperature. The final thickness of the precursor membrane was 5-50 micrometers.

It will be apparent to those skilled in the art that the latter embodiment can be scaled up to a roll-to-roll, continuous process.

In the case of either embodiment, multiple coatings can be applied to increase the membrane thickness or to facilitate filling of the porous material.

In the case of either embodiment, the precursor polymer membrane can be functionalized chemically or soaked in the aqueous or acohol solution of a QA compound shown above to convert the haloalkyl moieties within the precursor polymer to a quaternary ammonium head-group enabling anion conduction within the membrane. The mobile halogen counter ion (e.g. bromide, chloride or iodide) can later be exchanged with hydroxide ions.

Optionally, the precursor polymer membrane can contain or be soaked in a diamine, such as tetramethyl hexyldiamine, to cross-link some or all of the haloalkyl moieties. The cross-linking is preferably carried out before the amination reaction in trimethylamine; however, cross-linking may also be carried out after amination.

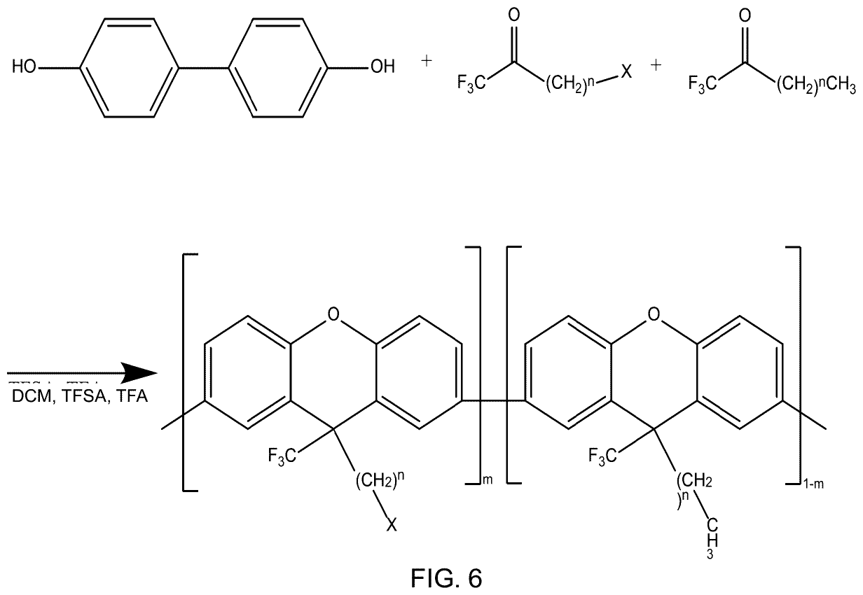

FIG. 6 shows the polymer structure of polyxanthene.

FIG. 6 shows the synthetic routes for the precursor polymer shown in formula (15P2-1).

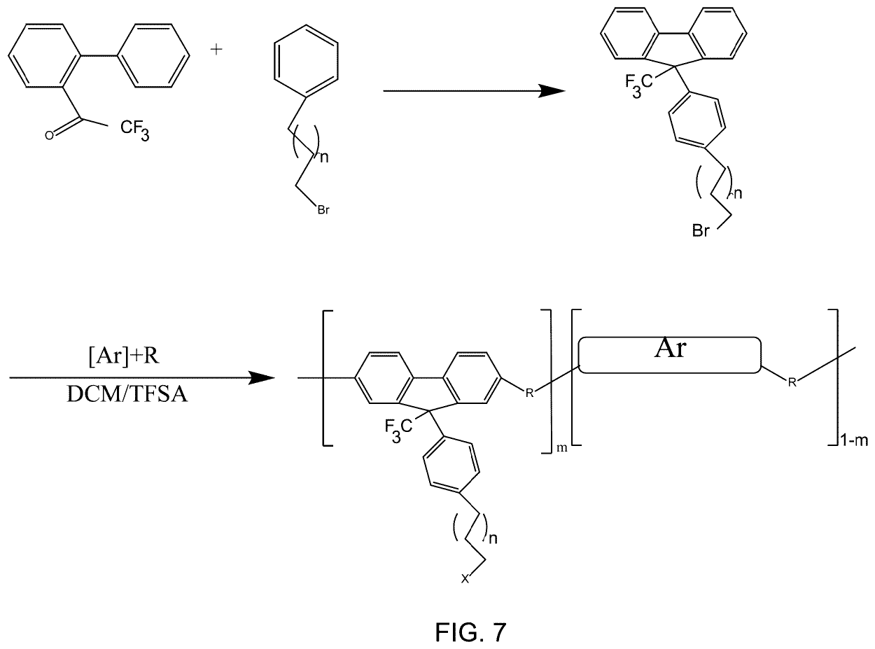

FIG. 7 shows the polymer structure of poly(fluorene-aryl) and the synthetic routes for the precursor polymer shown in formula (15P2-2).

The starting materials for the synthesis of the precursor polymer shown in formula (15P2-1) are all commercially available.

The synthesis of the starting monomer for the polymerization of the precursor polymer shown in formula (15P2-2) was firstly investigated, which was that for example 4 mmol 1-[1, 1′-Biphenyl]-2-yl-2,2,2-trifluoroethanone and 8.8 mmol (3-Bromopropyl) benzene were dissolved in 10 ml dichloromethane, then 5 ml trifluoromethanesulfonic acid was added dropwise to the solution. The reaction was running at room temperature for 4 hours before pouring the mixture into water. The crude compound was purified by chromatography after the step of extraction.

Details of the process for polymerizing the precursor polymer shown in formula (15P2-1) and (15P2-2) are further described separately in Example 15P2-1 and 15P2-2.

Example 15P2-1: Polymerization and functionalization of the precursor polymer shown in formula (15P2-1).

For the polymerization, the side chain with seven carbons was selected as an example. A 250 ml three-neck flask was added with a mixture of 4,4′-biphenol (1.0 eq), 7-bromo-1 1 1-trifluoro-2-heptanone and 1,1,1-Trifluoro-2-heptanone with a ratio (1:0˜1) (totally 1.1 eq) were added to dichloromethane. Then, trifluoromethanesulfonic acid was added to the mixture dropwise before the reaction finished within 90 minutes. The precursor polymer was precipitated by adding above mixture into methanol. The polymer was washed by hot methanol and water for three time. After the polymer is dried, the polymer was dissolved in a non-polar solvent such as chloroform, dichloromethane, tetrahydrofuran and toluene with weight percent of 1%-10% for further membrane casting. The membrane then was immersed in a QA compound solution for three days to get functionalized. Alternatively, the precursor polymer could be dissolved in a polar solvent such as DMSO, DMF, DMAC, then a QA compound ethanol solution was added to the polymer solution for running for three days at room temperature. The homogenously functionalized polymer was precipitated by pouring the solution into diethyl ether.

Example 15P2-2: Polymerization and functionalization of the precursor polymer shown in formula (15P2-2).

For the polymerization, 1.0 eq of the monomer synthesized above, 0-1 eq of an aromatic compound selected from the above group, and 2.2 eq of a linker compound selected from above group were dissolved in dichloromethane. Then trifluoromethanesulfonic acid was added to the mixture solution dropwise before the reaction finished in 9-12 hours. The precursor polymer was precipitated by adding the reaction mixture into methanol. The polymer was washed by hot methanol and water for three time. After the polymer is dried, the polymer was dissolved in a non-polar solvent such as chloroform, dichloromethane, tetrahydrofuran and toluene with weight percent of 1%-10% for further membrane casting. The membrane then was immersed in a QA compound solution for three days to get functionalized. Alternatively, the precursor polymer could be dissolved in a polar solvent such as DMSO, DMF, DMAc, then a QA compound ethanol solution was added to the polymer solution for running for three days at room temperature. The homogenously functionalized polymer was precipitated by pouring the solution into diethyl ether.

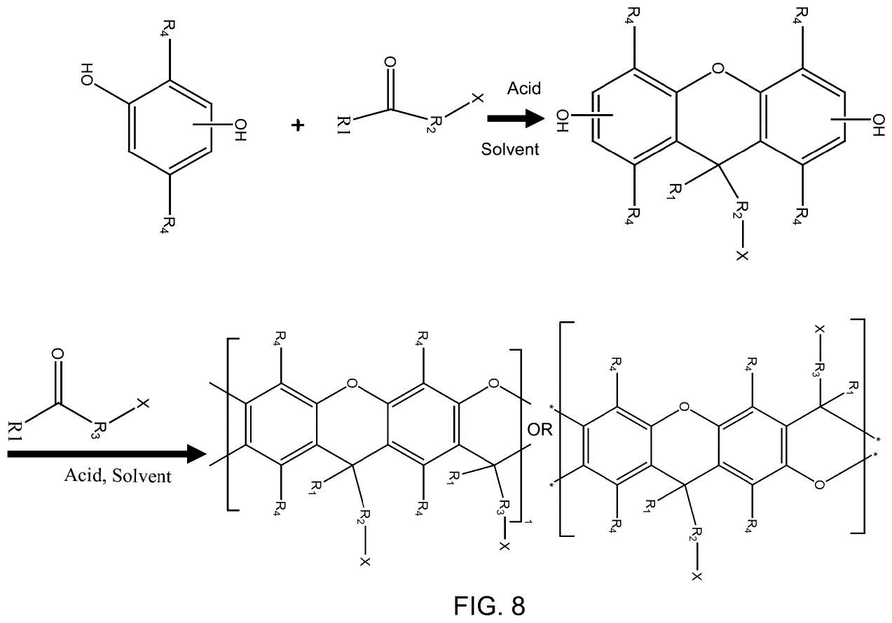

FIG. 8 shows the synthetic routes for the precursor polymer shown in formula (15P3-1) and (15P3-2).

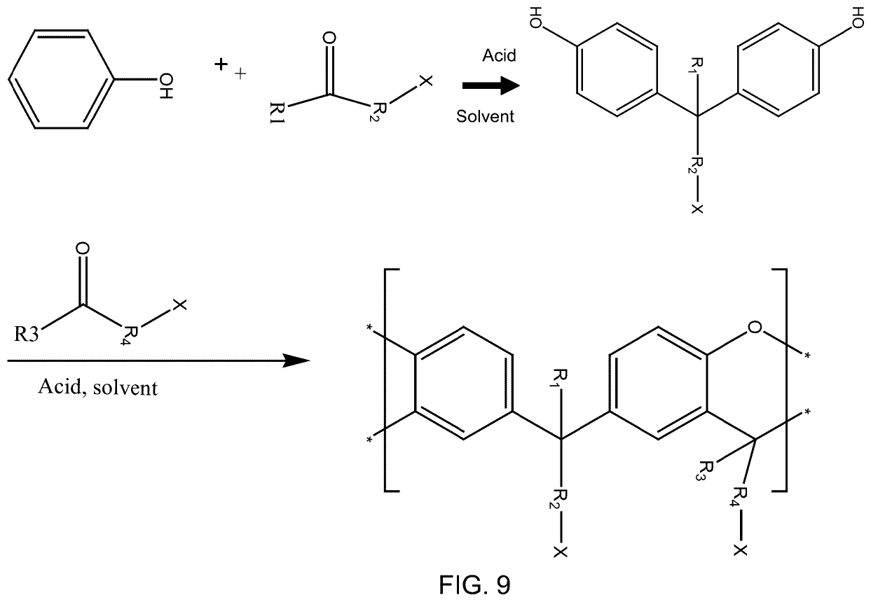

FIG. 9 shows the synthetic routes for the precursor polymer shown in formula (15P3-3).The starting materials for the synthesis of the precursor polymer shown in formula (15P3-1), (15P3-2), (15P3-3) are all commercially available. The synthesis of the starting monomer for the polymerization of the precursor polymer shown in formula (15P3-1) or (15P3-2) was referred by a published method, which was that for example 1 eq of either Resorcinol or 2-methylresorcino or hydroquinone and 0.5 eq of 2,2,2-trifluoroacetophenone were mixed in 40 ml dichloromethane, then 0.25 eq of trifluoromethanesulfonic acid was added dropwise to the solution. The reaction was running at room temperature for 4-8 hours before pouring the mixture into water. The crude compound collected was purified by recrystallization.

Details of the process for polymerizing the precursor polymer shown in formula (15P3-1) and (15P3-2) are further described separately in Example 15P3-1.

Example 15P3-1: Polymerization and functionalization of the precursor polymer shown in formula (15P3-1).

For the polymerization, the side chain with seven carbons was selected as an example. A 250 ml three-neck flask was added with a mixture of 4,4′-biphenol (1.3 eq), 7-bromo-1 1 1-trifluoro-2-heptanone and 1.0 eq of the monomer synthesized above were added to dichloromethane. Then, trifluoromethanesulfonic acid was added to the mixture dropwise before the reaction finished within 120 minutes. The precursor polymer was precipitated by adding above mixture into methanol. The polymer was washed by hot methanol and water three time. After the polymer is dried, the polymer was dissolved in a non-polar solvent such as chloroform, dichloromethane, tetrahydrofuran and toluene with weight percent of 1%-10% for further membrane casting. The membrane then was immersed in a QA compound solution for three days to get functionalized. Alternatively, the precursor polymer could be dissolved in a polar solvent such as DMSO, DMF, DMAc, then a QA compound ethanol solution was added to the polymer solution for running for three days at room temperature. The homogenously functionalized polymer was precipitated by pouring the solution into diethyl ether.

The synthesis of the starting monomer for the polymerization of the precursor polymer shown in formula (15P3-3) was referred by a published method, which was that for example 1 eq of 1-Methyl-4-piperidone, 2.1 eq of phenol and deionized water were added together and stirred in an argon atmosphere. After the reaction system was cooled to 0° C., sulfuric acid was carefully added dropwise into the solution and kept stirring at room temperature for a desired time monitored by TLC. The oily viscous mixture was diluted by adding hot acetone/methanol and transferred into a breaker. The resulting solution was neutralized by addition of 0.5 M Na₂CO₃, subsequently added ice to the white powder to completely precipitate. The product in sulfate form was further recrystallized from deionized water before drying, to obtain a white product.

Example 15P3-2: Polymerization and functionalization of the precursor polymer shown in formula (15P3-3).

For the polymerization, 1.0 eq of the monomer synthesized above, 1.3 eq 2,2,2-trifluoroacetophenone were mixed in dichloromethane, then a desired amount of trifluoromethanesulfonic acid was added dropwise to the solution. The reaction was running at room temperature for 2 hours before diluting with DMSO and then pouring the mixture into diethyl ether. The obtained polymer was washed by hot water three times. After the polymer is dried, the polymer was dissolved in a polar solvent with iodomethane and stirring for 48 hours before pouring the polymer solution into non-polar solvent to get functionalized ionomer

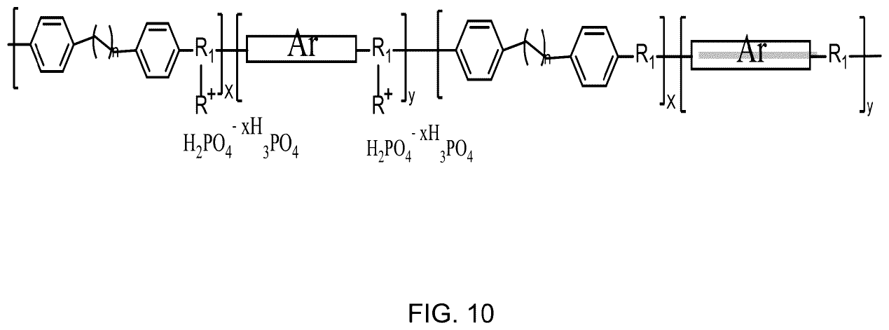

FIG. 10 shows a polymer diagram having a polyphenylene backbone wherein Ar is the polyphenylene backbones. The ionomers shown in formula (20P-1) and (20P-2) are prepared by superacid catalytic polymerization. In one embodiment, a membrane with the structure shown in formula (1) and the spacer shown in structure (20P-1) as well as formula (20P-2) are prepared by dissolving the precursor polymer in toluene at a 10% weight ratio i.e. 0.25 grams of polymer to 2.50 g of solvent. The mixture was stirred until homogenous and translucent.

The precursor polymer solution was then applied to a microporous polyethylene material tensioned around a chemically resistant plastic frame. The polymer solution was then poured on to the microporous scaffold. The frame was covered with a lid to slow solvent evaporation. The membrane was dried at room temperature. The final thickness of the precursor membrane was 5 micrometers.

In another embodiment, a membrane is prepared by dissolving the precursor polymer in toluene at a 5% weight ratio i.e. 0.3 grams of polymer to 5.7 g of solvent. The mixture was stirred until homogenous and translucent.

The precursor polymer was then applied to a microporous poly(tetrafluoroethylene) material with a doctor blade. The precursor polymer membrane was covered with a lid to slow solvent evaporation. The membrane was dried at room temperature. The final thickness of the membrane was 15 microns.

In one embodiment, a membrane shown in formula (20P-1) and with the spacer structure (20P-2) is prepared by dissolving the precursor polymer in polar solvent such as DMSO, NMP, DMF, DMAc at a 10% weight ratio i.e. 0.25 grams of polymer to 2.50 g of solvent. The mixture was stirred until homogenous and translucent.

The precursor polymer solution was then applied to a microporous polyethylene material tensioned around a chemically resistant plastic frame. The polymer solution was then poured on to the microporous scaffold. The frame was covered with a lid to slow solvent evaporation. The membrane was dried at room temperature. The final thickness of the precursor membrane was 5 micrometers.

In another embodiment, a membrane is prepared by dissolving the precursor polymer in polar solvent such as DMSO, NMP, DMF, DMAc at a 5% weight ratio i.e. 0.3 grams of polymer to 5.7 g of solvent. The mixture was stirred until homogenous and translucent.

The precursor polymer was then applied to a microporous poly(tetrafluoroethylene) material with a doctor blade. The precursor polymer membrane was covered with a lid to slow solvent evaporation. The membrane was dried at room temperature. The final thickness of the membrane was 15 microns

It will be apparent to those skilled in the art that the latter embodiment can be scaled up to a roll-to-roll, continuous process.

In the case of either embodiment, multiple coatings can be applied to increase the membrane thickness or to facilitate filling of the porous material.

In the case of either embodiment, the precursor polymer membrane can be functionalized chemically or soaked in trimethylamine solution in water or ethanol to convert the haloalkyl moieties within the precursor polymer to a trialkyl ammonium head-group enabling anion conduction within the membrane. The mobile halogen counter ion (e.g. bromide, chloride or iodide) can later be exchanged with hydroxide ions.

Optionally, the precursor polymer membrane can contain or be soaked in a diamine, such as tetramethyl hexyldiamine, to cross-link some or all of the haloalkyl moieties. The cross-linking is preferably carried out before the amination reaction in trimethylamine; however, cross-linking may also be carried out after amination.

Polymers compatible with porous scaffold embedded into it. The polymers consisted of an all-hydrocarbon polymer backbone which was chemically stable polymer even under harsh working conditions, such as 80° C. in 1 M NaOH. Efficient ion channels were engineered into the AEM by synthesis of a block copolymer. The block copolymer was composed of at least two blocks: hydrophilic ones which were functionalized with tethered cation groups for anion conduction, and hydrophobic ones to facilitate phase segregation of the polymer so as to form efficient anion conductive channels.

In addition to forming efficient ion conducting channels within the AEM material by itself, the AEM/scaffold composite has lower water uptake and is structurally more robust than the neat AEM polymer. Control over excess water uptake is a critical parameter is AEM applications. In addition, the poly(phenylene) polymer used here is compatible and sufficiently adherent to the scaffold to form a reliable integrated structure. The high intrinsic mechanical compliance and toughness of the poly(phenylene) AEM allows the use of very thin scaffolds resulting in composites which have very low area specific resistance and water uptake.

The syntheses of the two spacers shown in structure (20P-1) and (20P-2) are followed by literature method. Briefly for the spacer shown in structure 1, AlCl₃ was suspended in dichloromethane, then the mixture of trifluoroacetic anhydride and bromo-phenyl alkane were added to the solution and stirred for a desired period. The product shown in the structure 1 was extracted and purified through chromatography after completion of the reaction. For the side chain shown in structure 20P-2, 1,6-dibromohexane and N-methylpiperidine were reacting in acetone for 24 hours, the resulting white powder was washed three times with acetone without any other purification.

Details of a process for synthesizing the target ionomer shown in the FIG. 10 and are further described in Example 20P-1. The syntheses of the other co-polymeric component ratios are following a similar general procedure as described below.

Example 20P-1: Synthesis of the precursor anion conductive polymer for the phosphoric acid doping ion pair ion exchange membrane shown in FIG. 10.

For the synthesis, a 250 ml three-neck flask was added with a mixture of aromatic component (1.0 eq), diphenyl alkane (33% eq) and one of the spacer compounds shown in structure (20P-1) or (20P-2) (1.8 eq). The mixture was dissolved and stirrer in dichloromethane until the solution was clear. Then, trifluoracetic acid and triflic acid were added to the solution with a ratio of 1:2 and the mixture was stirrer under room temperature for 24 h until the mixture was viscous. Then, the mixture solution was poured into cold water and the resulting white precipitation was filtered out and washed with acetone and methanol for three times. After drying the resulting polymer under vacuum oven at higher temperature, the polymer was dissolved in DMSO and potassium carbonate was added to the mixture with 1-(6-Bromohexyl)-1-methylpiperidinium synthesized by following literature method. After 48 hours, the mixture was poured into acetone to obtain the precursor ionomer. The membrane was prepared by solution casting. N-piperidinium may include a functional group of methyl, ethyl or any other organic group.

Details of a process for preparing the final phosphoric acid doped ion pair ion exchange membrane based on the starting anion exchange polymer with a structure shown in the FIG. 10 and are further described in Example 20P-2.

Example 20P-2: The preparation of phosphoric acid doped ion pair ion exchange membrane was conducted in 85 wt % phosphoric acid. The precursor exchange membrane prepared above was soaked in NaOH solution for 12 hours in order to convert the starting anion exchange membrane from Br⁻ to OH⁻ form. After that, the membrane was transferred and soaked in 85 wt % phosphoric acid for 12 hours. Then the phosphoric acid doped ion exchange membrane was taken out of the phosphoric acid bath for drying for 72 hours.

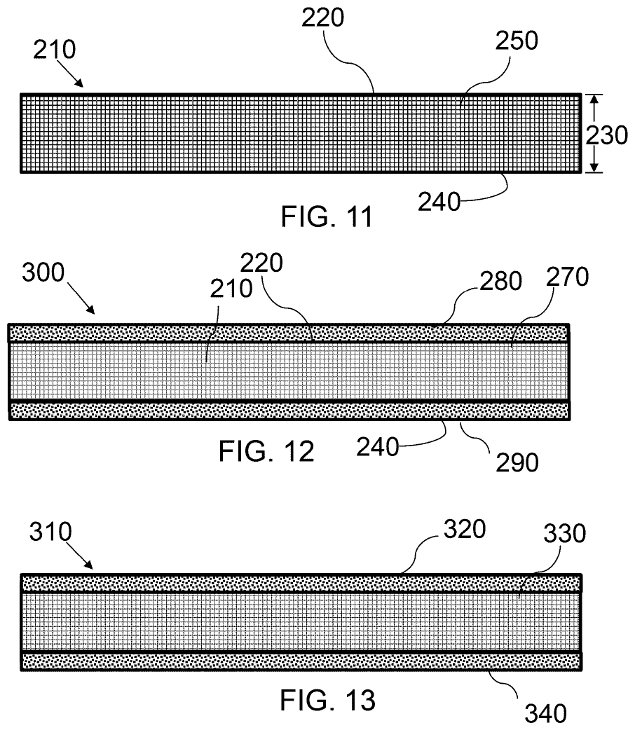

Referring now to FIG. 11 to FIG. 13. As shown in FIG. 11, an exemplary porous scaffold 10 has a thickness 230 from a first side 220 and an opposite second side 240. The porous scaffold has pores 250 and an open structure extending from the first side 220 to the second side 240, allowing for a flow of appropriate fluid from the first to the second side. The porous scaffold is air permeable when not imbibed with another solid material.

FIG. 12 shows a cross-sectional diagram of a composite precursor polymer membrane 300 comprising a porous scaffold 210 imbibed with a precursor polymer 270 which contains chemical moieties capable of forming fixed cation head-groups thereon. The precursor polymer forms surface layers 280 and 290 on the first side 220 and an opposite second side 240, respectively, of the porous scaffold shown in FIG. 11.

Polymers compatible with porous scaffold embedded into it. The polymers consisted of an all-hydrocarbon polymer backbone which was chemically stable polymer even under harsh working conditions, such as 80° C. in 1 M NaOH. Efficient ion channels were engineered into the AEM by synthesis of a block copolymer. The block copolymer was composed of at least two blocks: hydrophilic ones which were functionalized with tethered cation groups for anion conduction, and hydrophobic ones to facilitate phase segregation of the polymer so as to form efficient anion conductive channels

In addition to forming efficient ion conducting channels within the AEM material by itself, the AEM/scaffold composite has lower water uptake and is structurally more robust than the neat AEM polymer. Control over excess water uptake is a critical parameter is AEM applications. In addition, the poly(phenylene) polymer used here is compatible and sufficiently adherent to the scaffold to form a reliable integrated structure. The high intrinsic mechanical compliance and toughness of the poly(phenylene) AEM allows the use of very thin scaffolds resulting in composites which have very low area specific resistance and water uptake.

FIG. 13 shows a cross-sectional diagram of a composite anion exchange membrane 310 formed after treating the precursor polymer membrane 100 with trimethylamine, forming the fixed cation head groups. The leaving groups of the precursor polymer 270 have been replaced with quaternary ammonium functional groups, producing an anion conductive (exchange) polymer 330 which is sufficiently imbibed in the porous scaffold 320. The anion exchange polymer may be fully imbibed into the porous scaffold, Optionally, the precursor polymer could be cross-linked before or after amination, or not at all. The composite anion conductive polymer forms surface layers 320 and 340 on the two sides or surfaces of the imbibed porous scaffold.

The starting polymer is prepared by superacid catalytic polymerization. The precursor polymer solution was then applied to a microporous polyethylene material tensioned around a chemically resistant plastic frame. The polymer solution was then poured on to the microporous scaffold. The frame was covered with a lid to slow solvent evaporation. The membrane was dried at room temperature. The final thickness of the precursor membrane was 5 micrometers.

The starting polymer was then applied to a microporous poly(tetrafluoroethylene) material with a doctor blade. The starting polymer membrane was covered with a lid to slow solvent evaporation. The membrane was dried at room temperature. The final thickness of the membrane was 15 microns.

The precursor polymer was then applied to a microporous poly(tetrafluoroethylene) material with a doctor blade. The precursor polymer membrane was covered with a lid to slow solvent evaporation. The membrane was dried at room temperature. The final thickness of the membrane was 15 microns

It will be apparent to those skilled in the art that the latter embodiment can be scaled up to a roll-to-roll, continuous process.

In the case of either embodiment, multiple coatings can be applied to increase the membrane thickness or to facilitate filling of the porous material.

In the case of either embodiment, the precursor polymer membrane can be functionalized chemically with phosphonate group

Optionally, the precursor polymer membrane can contain or be soaked in a diamine, such as tetramethyl hexyldiamine, to cross-link some or all of the haloalkyl moieties. The cross-linking is preferably carried out before the amination reaction in trimethylamine; however, cross-linking may also be carried out after amination.

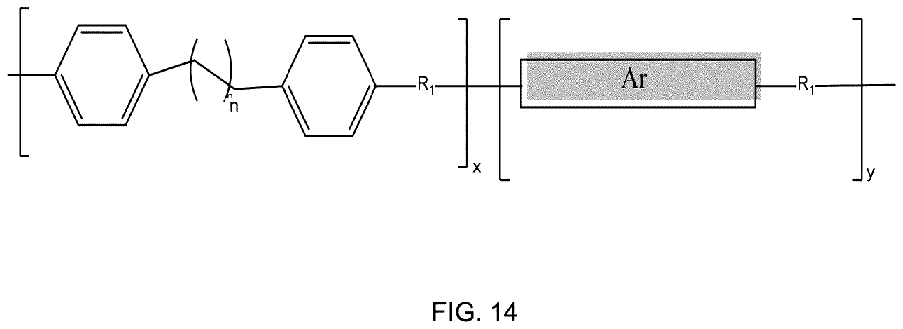

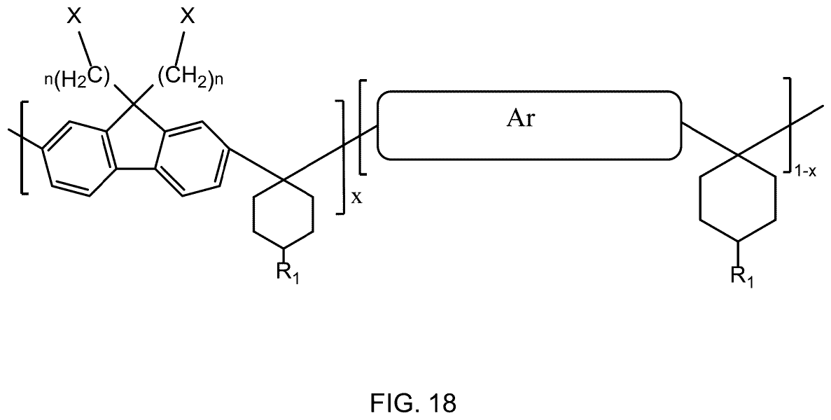

FIGS. 14 and 18 show a starting polymer diagram having a polyphenylene backbone wherein Ar is the polyphenylene backbones

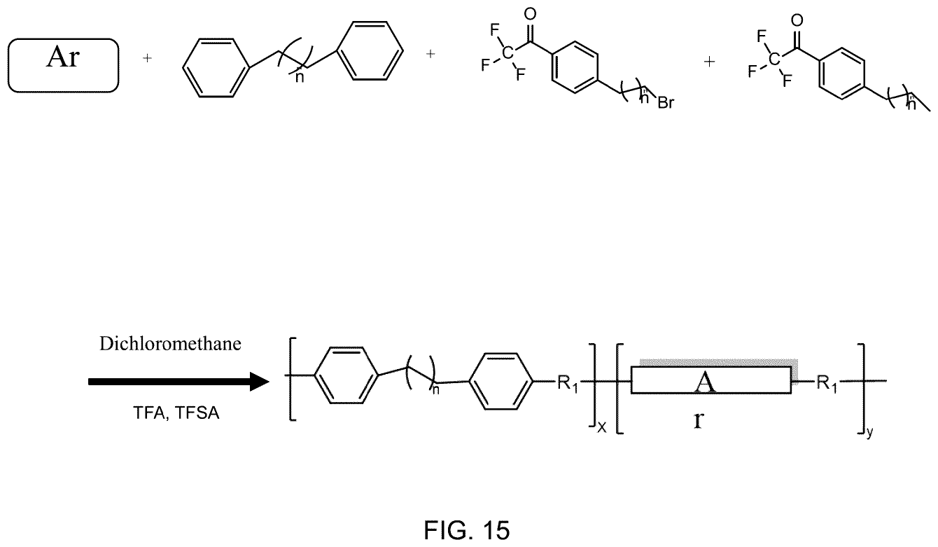

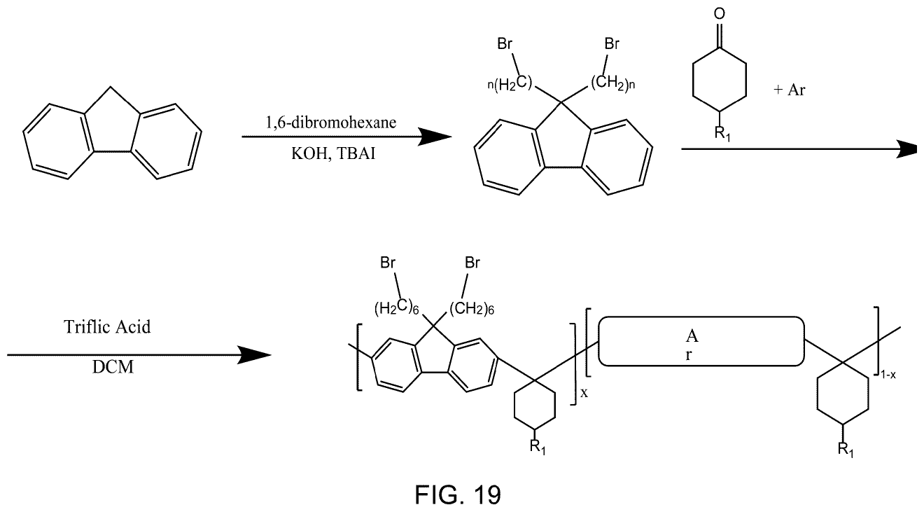

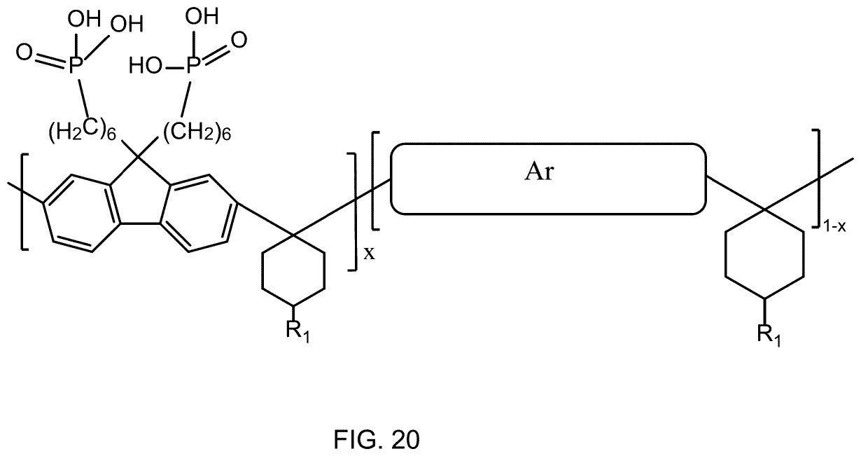

Referring to FIGS. 15 and 19, according to one embodiment, a synthetic route and a composition are disclosed. The polymer is produced by reaction of compounds including poly(phenylene) and polyfluorene that form the backbone of the polymer.

The syntheses of the spacers are followed by literature method. Briefly for the spacer shown in structure 1, AlCl₃ was suspended in dichloromethane, then the mixture of trifluoroacetic anhydride and bromo-phenyl alkane were added to the solution and stirred for a desired period. The product shown in the structure 1 was extracted and purified through chromatography after completion of the reaction.

Details of a process for synthesizing the target ionomer shown in the FIG. 14 and are further described in Example 24P-1. The syntheses of the other co-polymeric component ratios are following a similar general procedure as described below.

Example 24P-1: Synthesis of the starting anion conductive polymer shown in FIG. 14.

For the synthesis, a 250 ml three-neck flask was added with a mixture of aromatic component (1.0 eq), 9,9-Dialkanexanthene with twisted structure (33% eq) and the diphenyl alkane (33% eq) and one of the spacer compounds (1.8 eq). The mixture was dissolved and stirrer in dichloromethane until the solution was clear. Then, trifluoracetic acid and triflic acid were added to the solution with a ratio of 1:2 and the mixture was stirrer under room temperature for 24 h until the mixture was viscous. Then, the mixture solution was poured into cold water and the resulting white precipitation was filtered out and washed with acetone and methanol for three times. After drying the resulting polymer under vacuum oven at higher temperature, the polymer was dissolved in DMSO and potassium carbonate was added to the mixture with 1-(6-Bromohexyl)-1-methylpiperidinium synthesized by following literature method. After 48 hours, the mixture was poured into acetone to obtain the target ionomer shown in FIG. 14.

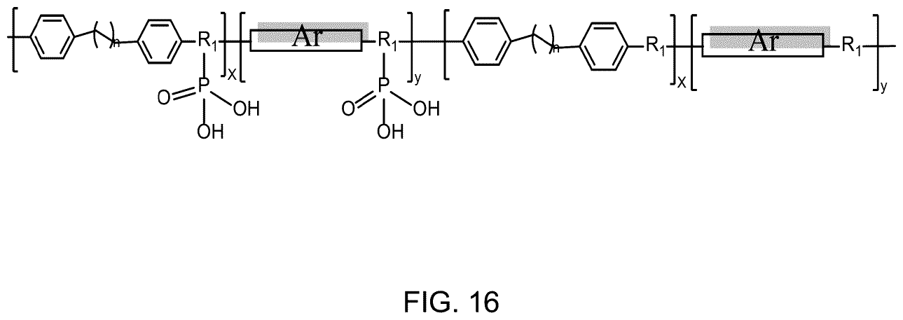

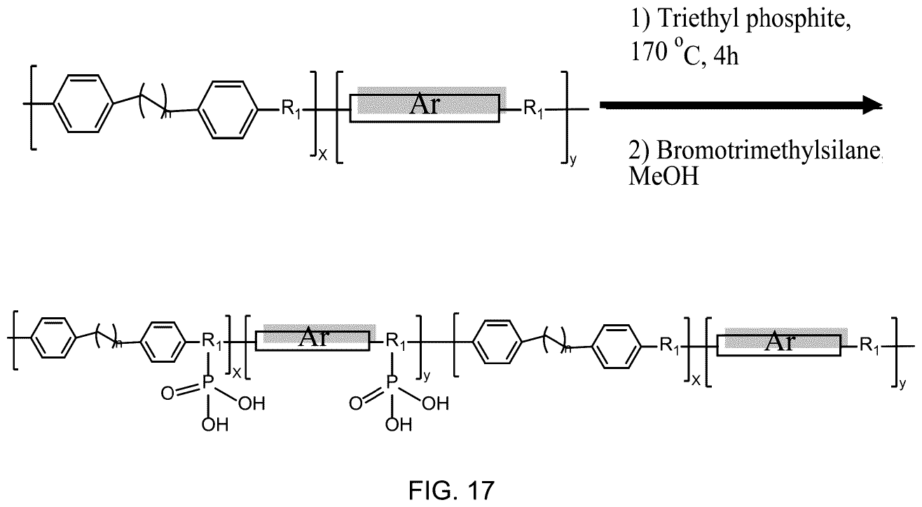

Details of a process for preparing covalently bonding phosphoric acid ion pair ion exchange membrane shown in FIG. 16 based on the starting co-polymer with a structure shown in the FIG. 14 and are further disclosed in FIG. 17 and described in Example 2

Example 24-2: The starting co-polymer was dispersed in triethyl phosphite and refluxed at 170° C. for 4 hours under inert atmosphere. Excessive triethyl phosphite was evaporated under reduced pressure. To the obtained solid was added dichloromethane and bromotrimethylsilane dropwise. The resulting solution was stirred for 12 hours at room temperature after the addition. The solvent then was removed and methanol was added to the mixture for keeping stirring for 12 hours. Removing the methanol and washing the resulting polymer solid with water for three times.

Details of a process for synthesizing the target ionomer shown in the FIG. 18 and are further described in Example 24P-1. The syntheses of the other co-polymeric component ratios are following a similar general procedure as described below. The monomer 9,9-Bis(6-bromohexyl)-9H-fluorene was synthesized according to published method.

Example 24P-3: Synthesis of the starting anion conductive polymer shown in FIG. 18.

For the synthesis, a 100 ml three-neck flask was added with a mixture of 9,9-Bis(6-bromohexyl)-9H-fluorene (2.4 g, 4.88 mmol, 1.0 eq), aromatic compound selected from the structure 3 (0.5%-1.5% eq), alkylcyclohexanonce (1.2 eq), 8 ml trifluoromethanesulfonic acid, 2 ml trifluoracetic acid in 8 ml dichloromethane under argon. The mixture was running at room temperature for 7-12 h until the mixture is viscous. Then, the mixture solution was poured into cold methanol and white precipitation was obtained through vacuum filtration. After washing the solids with hot methanol and water, the aqueous solution containing trimethylamine was added with the solids and stirred at room temperature for overnight. The target ionomer was obtained after vacuum filtration and washing with water.

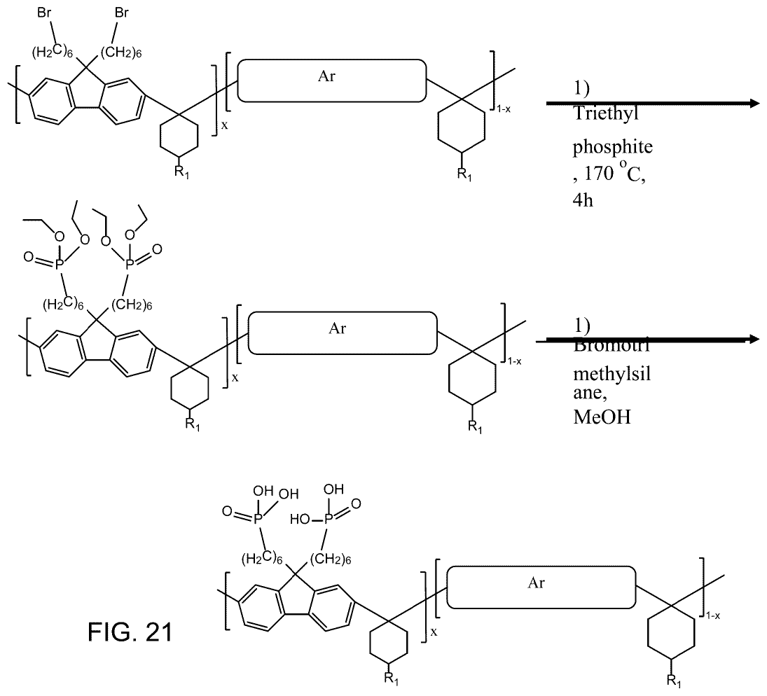

Details of a process for preparing covalently bonding phosphoric acid ion pair ion exchange membrane shown in FIG. 16 based on the starting co-polymer with a structure shown in FIG. 18 and are further disclosed in FIG. 21 and described in Example 24P-2.

Example 24P-4: The polymer synthesized from the example 3 was dispersed in triethyl phosphite and refluxed at 170° C. for 4 hours under inert atmosphere. Excessive triethyl phosphite was evaporated under reduced pressure. To the obtained solid was added dichloromethane and bromotrimethylsilane dropwise. The resulting solution was stirred for 12 hours at room temperature after the addition. The solvent then was removed and methanol was added to the mixture for keeping stirring for 12 hours. Removing the methanol and washing the resulting polymer solid with water for three times.

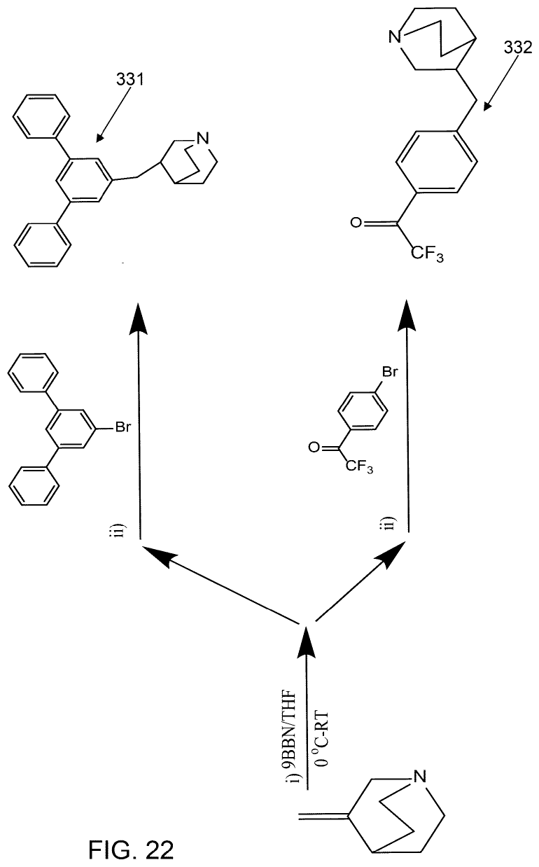

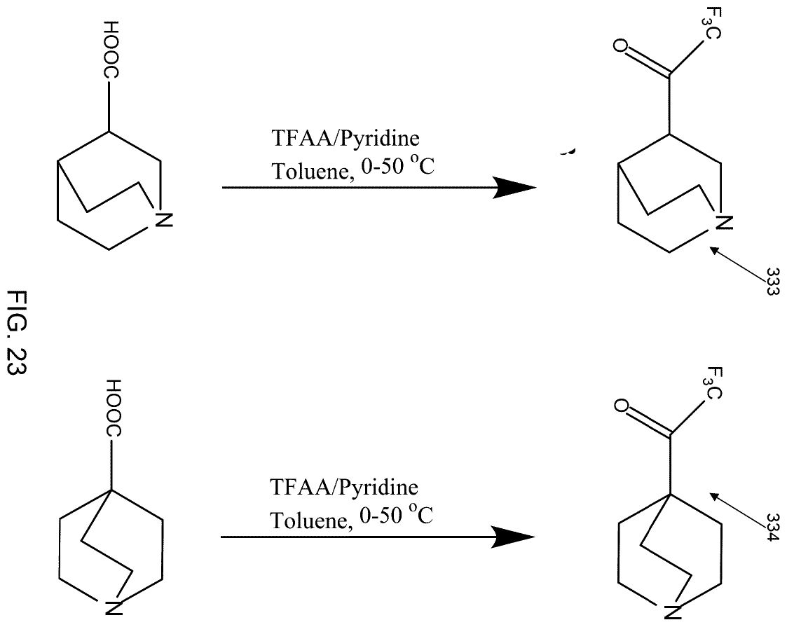

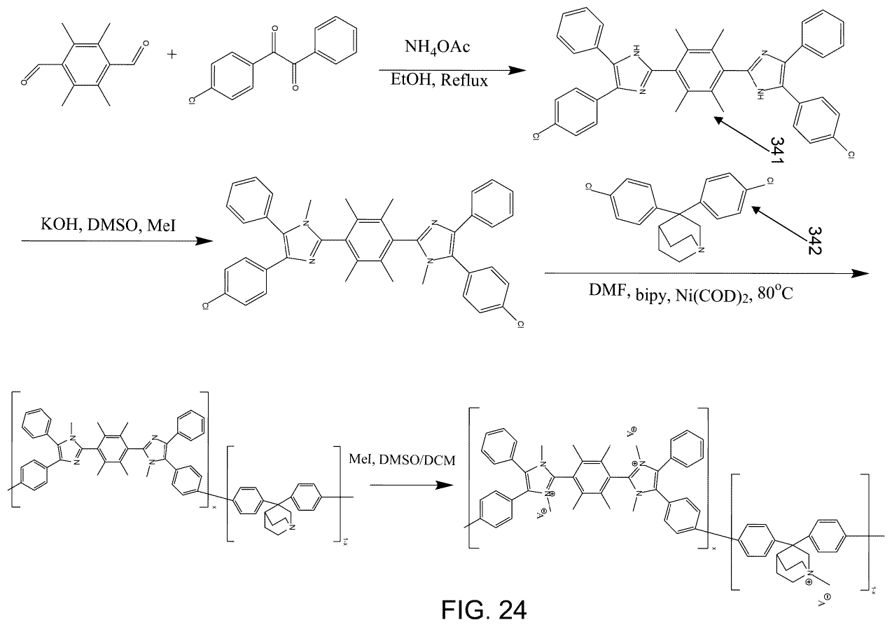

According to one embodiment, as shown in FIGS. 22 and 23, a synthetic route and a composition are disclosed. The composition includes one compound with poly(phenylene) backbones. The backbone of the polymer structure shown below consists of aryl rings, wherein one of the aryl rings links to a sidechain at para-position including a trifluoromethyl-based spacers and N-methylquinuclidiniumquaternary functional group.

Monomers 331, monomer 332, monomer 333, and monomer 334 were synthesized through a published method shown in FIGS. 22 and 23. Details of a process for synthesizing the anion conductive polymer and casting anion exchange membrane are presented in Example 1.

Example 33-1:

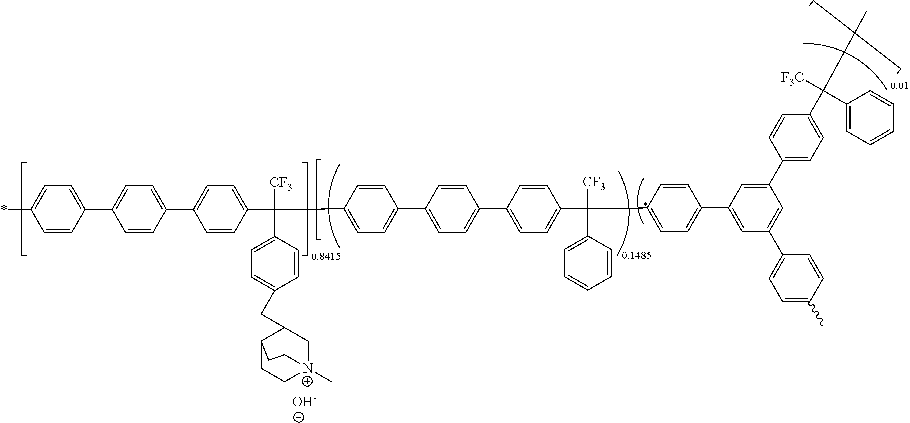

The polymer was synthesized via super-acid catalyzed polycondensation, which compromises that homogeneously mixing p-terphenyl (0.69 g, 3.0 mmol), 2,2,2-trifluoro-1-(4-(quinuclidin-3-ylmethyl)phenyl)ethan-1-one (Monomer 2, 0.83 g, 2.78 mmol), 2,2,2-Trifluoro-1-phenylethanone (0.09 g, 0.52 mmol) and 1,3,5-triphenylbenzene (9.2 mg, 0.03 mmol) in dichloromethane, then the mixture was stirred at room temperature for 24 hours under the catalysis of TFSA. The resulting gel-like mixture was diluted with DMSO and poured into isopropanol to obtain white fiber-like polymer before washing the product with diethyl ether and drying under vacuum overnight.

The quaternization for obtaining final anion exchange polymer was carried out through mixing 1 equivalent of the polymer obtained above, 3 equivalent K₂CO₃, 5 equivalent iodomethane in 10 ml DMSO and stirring for 48 hours under dark environment before pouring the resulting mixture to isopropanol to obtain final anion conductive polymer.

The anion exchange membrane was prepared by dissolving the anion conductive polymer in DMSO to form 5 wt % solution, and then cast membranes on reinforced scaffold porous support material using doctor blade. The resulting membranes were immersed in 1M KBr solution for a week to fully convert to bromine form after completely evaporating DMSO. As needed, the anion exchange membranes can be converted to hydroxide form by immersing in NaOH solution for 3-4 days under inert atmosphere.

It will be apparent to those skilled in the art that various modifications, combinations, and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

Monomers shown in FIG. 24 were purchased and synthesized through a published method. Details of a process for synthesizing the anion conductive polymer and casting anion exchange membrane are presented in Example 34-1.

Example 34-1: Monomer 341 and Monomer 342 shown in FIG. 24 are polymerized to form the co-polymer shown below:

Co-polymer of monomer 341 and monomer 342 shown below:

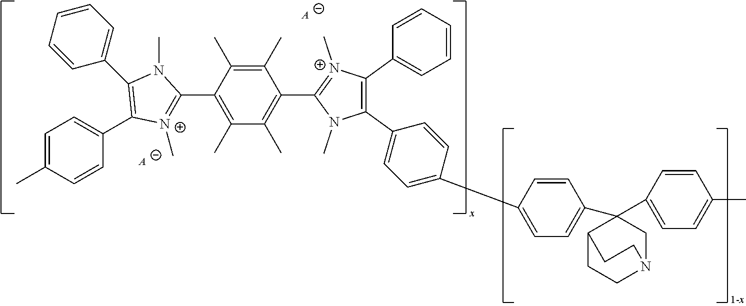

The monomers shown in FIG. 24 were synthesized by mixing 1,4-dialdehyde-2,3,5,6-tetramethylbenzene (0.57g, 3.0 mmol), chlorobenzil (1.61 g, 6.6 mmol), and ammonium acetate (4.6 g, 60 mmol) were added with 15 mL acetic acid and 60 mL ethanol. The reaction mixture was heated to reflux for 18 h. The reaction was then cooled to room temperature and poured into water. The precipitate was recrystallized from acetonitrile/water to give the monomer 341. The monomer 342 was synthesized by mixing 3-quinuclidone and chlorobenzene which was catalyzed by triflic acid to give the monomer 342. The polymer was synthesized via Yamamoto coupling polymerization, which compromises homogeneously mixing the monomer 1 and monomer 2 in DMF, then the mixture was catalyzed by Ni(COD)₂ and bipyridine and stirred at 80° C. for 20 hours. The resulting solution was poured to HCl aqueous solution to get the precipitation of the polymer.

The quaternization for obtaining final anion exchange polymer was carried out through mixing 1 equivalent of the polymer obtained above, 3 equivalent K₂CO₃, 5 equivalent iodomethane in 10 ml DMSO/DCM and stirring for 48 hours under dark environment before pouring the resulting mixture to isopropanol to obtain final anion conductive polymer.

The anion exchange membrane was prepared by dissolving the anion conductive polymer in DMSO to form 5 wt % solution, and then cast membranes on reinforced scaffold porous support material using doctor blade. The resulting membranes were immersed in 1M KBr solution for a week to fully convert to bromine form after completely evaporating DMSO. As needed, the anion exchange membranes can be converted to hydroxide form by immersing in NaOH solution for 3-4 days under inert atmosphere.

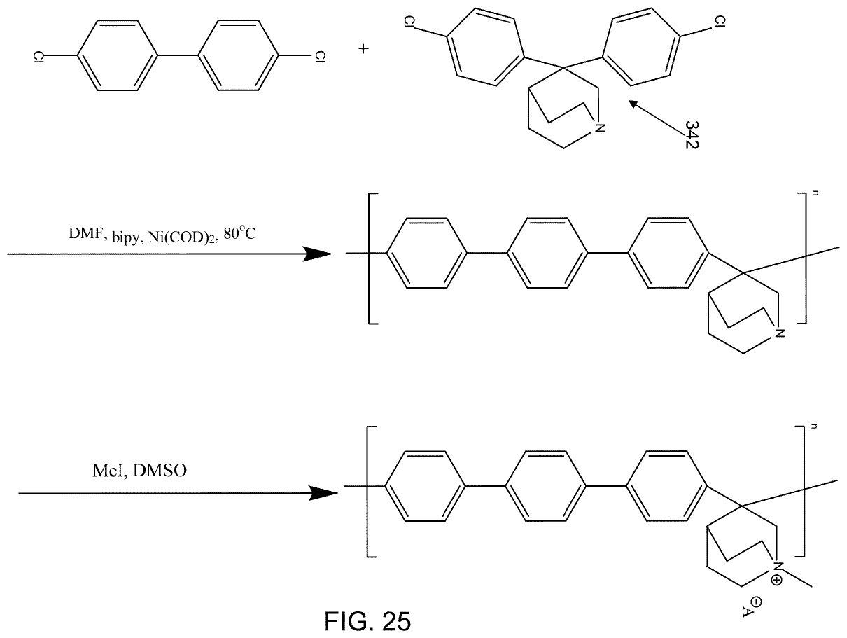

With reference to FIG. 25, monomer 342 was synthesized by mixing 3-quinuclidone and chlorobenzene which was catalyzed by triflic acid to give the monomer 342. The polymer was synthesized via Yamamoto coupling polymerization, which compromises homogeneously mixing the monomer 342 with 4,4′-dichloro-1,1′-biphenyl in DMF, then the mixture was catalyzed by Ni(COD)₂ and bipyridine and stirred at 80° C. for 20 hours. The resulting solution was poured to HCl aqueous solution to get the precipitation of the polymer.

The quaternization for obtaining final anion exchange polymer was carried out through mixing 1 equivalent of the polymer obtained above, 3 equivalent K₂CO₃, 5 equivalent iodomethane in 10 ml DMSO/DCM and stirring for 48 hours under dark environment before pouring the resulting mixture to isopropanol to obtain final anion conductive polymer.

The anion exchange membrane was prepared by dissolving the anion conductive polymer in DMSO to form 5 wt % solution, and then cast membranes on reinforced scaffold porous support material using doctor blade. The resulting membranes were immersed in IM KBr solution for a week to fully convert to bromine form after completely evaporating DMSO. As needed, the anion exchange membranes can be converted to hydroxide form by immersing in NaOH solution for 3-4 days under inert atmosphere.

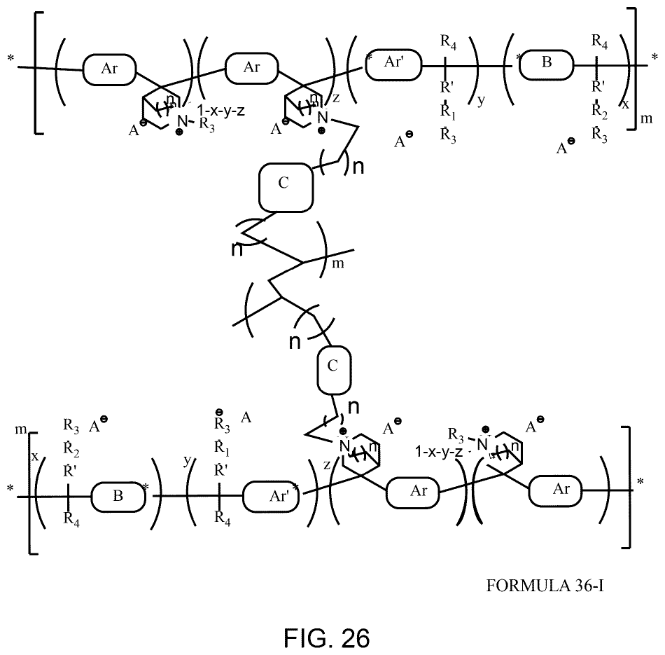

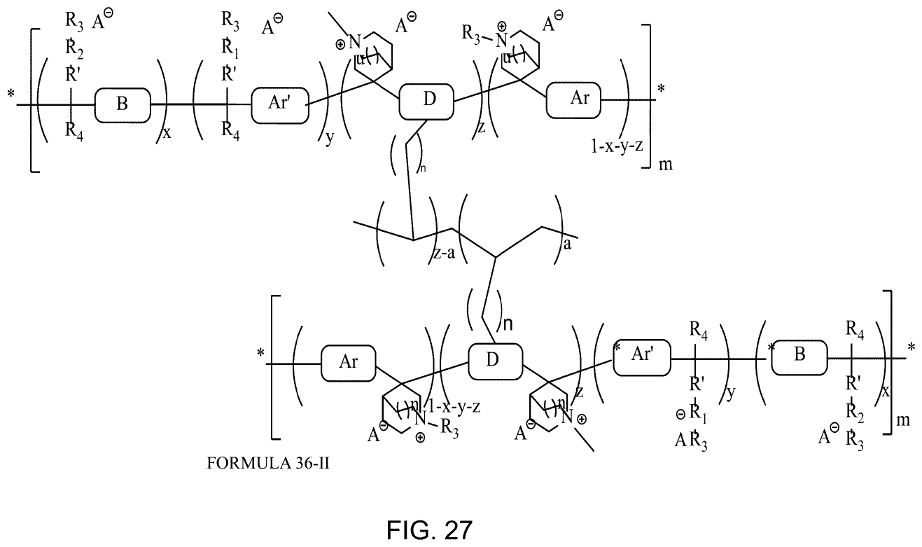

With reference to FIG. 26 and FIG. 27, this invention introduces a novel in-situ poly(crosslinker) tailored to enhance the branched poly(aryl-co-aryl quinuclidinium) structure, specifically designed to significantly improve the mechanical strength of the material. This innovative approach is optimized for applications in anion exchange membranes, addressing critical performance requirements in demanding environments such as water electrolysis for green hydrogen production. By focusing on this advanced crosslinking technique, the invention provides a robust solution to achieving high durability and mechanical stability without compromising the material's functional properties, as shown in FIG. 26:

Wherein Ar is selected from one of or multiple of the compounds from the group of aromatic compounds; Ar′ is selected from one of or multiple of the compounds from the group of aromatic compounds; B is selected from one of or multiple of the compounds from the group of branching agents; C is selected from one of or multiple of the compound from the group of aromatic compounds or hydrocarbon compounds or aliphatic compounds or N-containing compounds. D is selected from one of or multiple compounds from the group of aromatic compounds or N-containing compounds. x is the mole fraction of branching agent which is in the range of 0.001-1; y is in the range of 0-0.999, z is in the range of 0.01-1, and 0.001<x+y+z<1.0; m is degree of polymerization which is in the range of 10-1000000. n is in the range of 0-10;
R′ is the same or different and independently of each other selected from the group consisting of hydrogen, alkyl, alkylene, cycloalkylene, arylene. R1, R2 are the same or different and independently of each other selected from hydrogen atom or the structures below together or independently and A⁻ is selected from halogen, hydroxide, or carbonate anions:

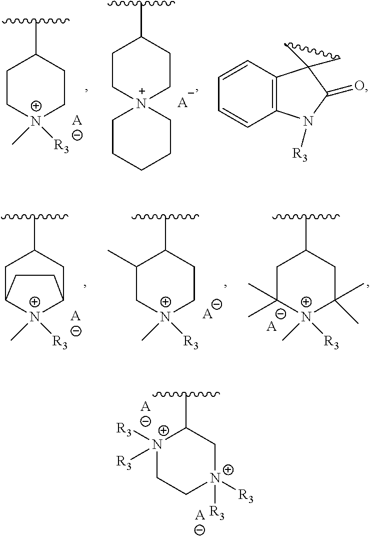

R3 is the same or different and independently of each other selected from hydrogen or the structures below and A-is selected from halogen, hydroxide, or carbonate anions: —(CH₂)ₙCH₃ (n=0-10);

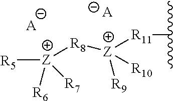

Wherein:
R8 and R11 are each independently alkyl, alkylene, alkynyl, aryl
R5, R6, R7, R9, R10 are each independently alkyl, alkylene, alkynyl, aryl
Z is N or P
For example a linear structure:

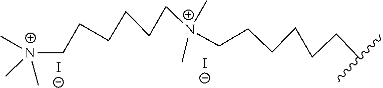 [SMILES: *CCCCCC[N+](C)(C)CCCCCC[N+](C)(C)C ; [I-] ; [I-]]

A cyclic structure

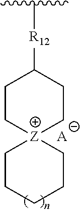

Wherein:
R12 is selected from alkyl, alkylene, alkynyl, aryl, prefer C1-C6
n=1-10
Z is selected from N or P
X is halogen such as I, Br, Cl

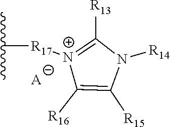

### Wherein

R13, R14, R15, R16, R17 are the same or independently selected from alkyl, alkylene, alkynyl, aryl
For example:

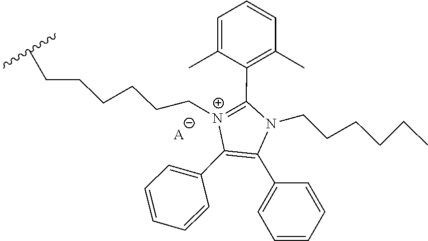

R4 is selected from CF3, proton
Ar is selected from one or multiple of the aromatic compounds having the structures below:

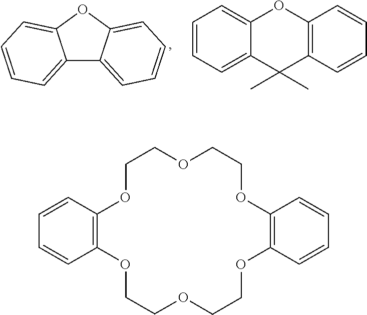

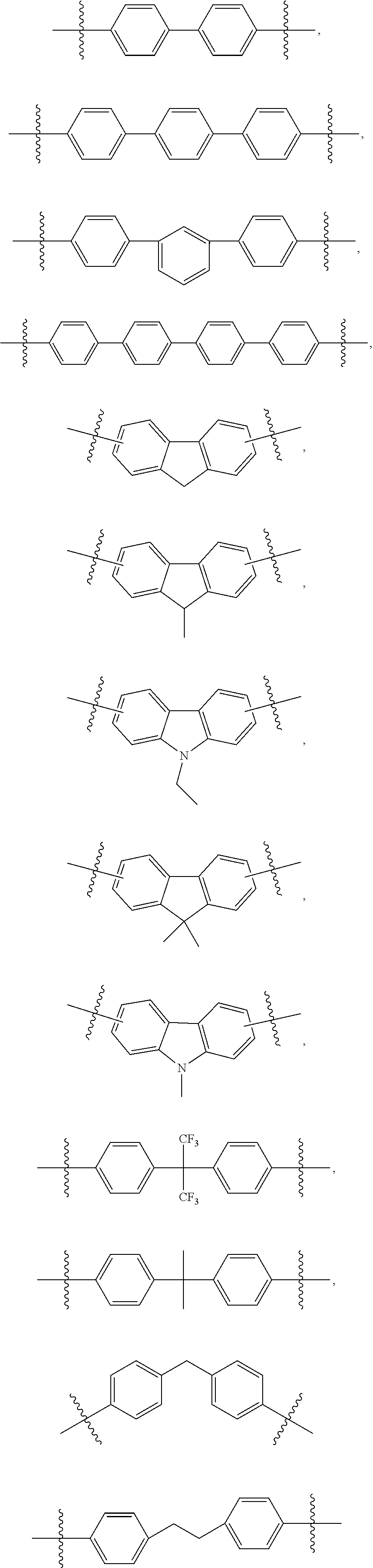

Ar′ is selected from one or multiple of the aromatic compounds from the group above or from the aromatic compounds containing quaternary ammonium salt cations and having the structures below:

### Wherein:

,
B is selected from one of or multiple of the compounds from the group below:

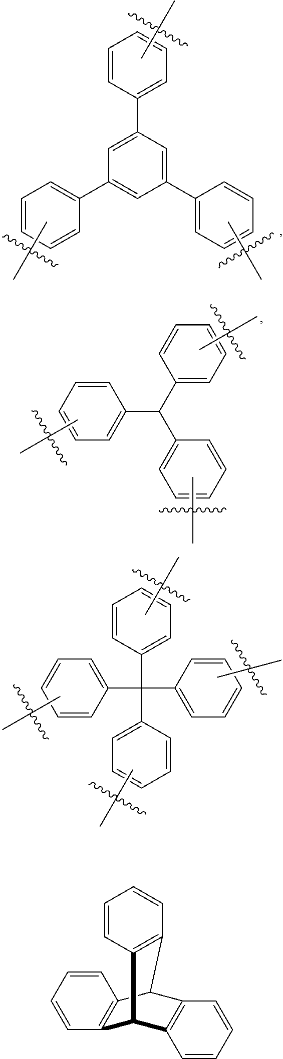

C is selected from one of or multiple of the compounds from the group comprising:

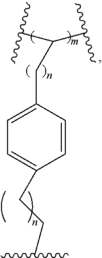

D is selected from one of or multiple of the compounds from the group comprising:

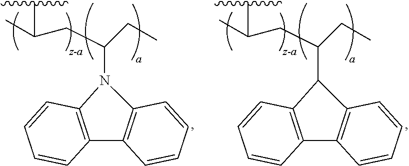

A method of synthesizing in-situ crosslinked branched poly(aryl-co-aryl quinuclidinium) shown in FORMULA36-I is through polycondensation under the catalysis of one or both of strong acids such as trifluoromethanesulfonic acid (TFSA) and trifluoroacetic acid (TFA), which comprises those reacting monomers selected from as example Ar, Ar′ and B as well as quinuclidinium derivative, trifluoroalkyl ketone derivatives and the crosslinking through the formation of polystyrene. The reaction equation is shown in FIG. 4. A branching compound enables higher entanglement of the polymer to prevent slipping and creep and overall mechanical properties including toughness and higher modulus. Also, a branching compound may enable high IEC as the functional sites may be configured more closely together. Also, the polymer as described herein may include multiple functional groups per side chain that can increase IEC. The in-situ crosslinking induced by the polymerization of a monomer initiate by heating process may increase the mechanical strength of poly(aryl-co-aryl quinuclidinium) which optionally avoids the usage of ex-situ reinforcements such as PP, PE, PTFE, PEEK

A method of synthesizing in-situ crosslinked branched poly(aryl-co-aryl quinuclidinium) shown in Formula 36-I is through polycondensation under the catalysis of one or both of strong acids such as trifluoromethanesulfonic acid (TFSA) and trifluoroacetic acid (TFA), which comprises those reacting monomers selected from as example Ar, Ar′, D and B as well as quinuclidinium derivative, trifluoroalkyl ketone derivatives The reaction equation is shown in FIG. 5. A branching compound enables higher entanglement of the polymer to prevent slipping and creep and overall mechanical properties including toughness and higher modulus. Also, a branching compound may enable high IEC as the functional sites may be configured more closely together. Also, the polymer as described herein may include multiple functional groups per side chain that can increase IEC. The in-situ crosslinking induced by the polymerization of a monomer unit integrated to the backbone of the polymer chain initiate by heating process may increase the mechanical strength of poly(aryl-co-aryl quinuclidinium) which optionally avoids the usage of ex-situ reinforcements such as PP, PE, PTFE, PEEK.

Either dibenzofuran or xanthene are hydrophilic unit which is beneficial for phase separation morphology and subsequently increases conductivity.

With reference to FIG. 26 and FIG. 27, the poly(aryl-co-aryl quinuclidinium) was synthesized via super-acid catalyzed polycondensation, which compromises that homogeneously mixing p-terphenyl (0.69 g, 3.0 mmol), 3-quinuclidione in chloride form (0.45 g, 2.78 mmol), 2,2,2-Trifluoroacetophenone (0.09 g, 0.52 mmol) and 1,3,5-triphenylbenzene (9.2 mg, 0.03 mmol) in dichloromethane, then the mixture was stirred at room temperature for 24 hours under the catalysis of TFAS. The resulting gel-like mixture was diluted with DMSO and poured into isopropanol to obtain white fiber-like polymer before washing the product with diethyl ether and drying under vacuum overnight.

The quaternization for obtaining final anion exchange polymer was carried out through mixing 1 equivalent of the polymer obtained above, 0.17 equivalent 4-vinylbenzyl chloride, 3 equivalent K2CO3, 5 equivalent iodomethane in 10 ml DMSO and stirring for 48 hours under dark environment before pouring the resulting mixture to isopropanol to obtain final anion conductive polymer.

The anion exchange membrane was prepared by dissolving the anion conductive polymer in DMSO to form 1-3 wt % solution and then cast membranes on reinforced scaffold porous support material using doctor blade before the heating process. The resulting membranes were immersed in 1M KBr solution for a week to fully convert to bromine form after completely evaporating DMSO. As needed, the anion exchange membranes can be converted to hydroxide form by immersing in NaOH solution for 3-4 days under inert atmosphere.

It will be apparent to those skilled in the art that various modifications, combinations, and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. An ion conducting polymer comprising:
a) a backbone comprising poly(arylene) and a branching compound;
b) side chains including first side chains that are functionalized, wherein said first side chains each include a N-heterocyclic compound;
c) functional groups that functionalize the N-heterocyclic compound form quinuclidinium, wherein the functional groups are bonded to said first side chains.

2. The ion conducting polymer of claim 1, wherein the branching compound has two or more benzene rings, each with a bonding site.

3. The ion conducting polymer of claim 2, wherein the poly(arylene) comprises a copolymer of polyphenylene and polyxanthene.

4. The ion conducting polymer of claim 2, wherein the poly(arylene) comprises a copolymer of polyphenylene and polydibenzofuran.

5. The ion conducting polymer of claim 1, wherein the poly(arylene) comprises a copolymer of polyphenylene and polyxanthene.

6. The ion conducting polymer of claim 1, wherein the poly(arylene) comprises a copolymer of polyphenylene and polydibenzofuran.

7. The ion conducting polymer of claim 1, wherein the branching compound comprises 1,3,5-triphenylbenzene.

8. The anion conducting polymer of claim 1, further comprising second side chains selected from the group consisting of hydrogen, alkyl, alkylene, alkynyl, cycloalkylene, arylene and trifluoromethyl (CF3).

9. The anion conducting polymer of claim 1, wherein the functional groups include a compound selected from the group consisting of alkyl, alkylene, alkynyl, aryl.

10. The anion conducting polymer of claim 1, wherein the anion conducting co-polymer is crosslinked by a crosslinker compound.

11. The anion conducting polymer of claim 10, wherein the crosslinker compound comprises a halogenated compound.

12. The anion conducting polymer of claim 10, wherein the crosslinker compound is selected from the group consisting of alkyl, alkylene, alkynyl, and aryl.

13. The ion conducting polymer of claim 1, wherein the first side chain further comprises arylene compound or an aliphatic compound that is bonded with the N-heterocyclic compound.

14. The ion conducting polymer of claim 1, wherein the first side chain further comprises trifluoromethyl compound that is bonded with the N-heterocyclic compound.

15. The ion conducting polymer of claim 1, wherein the backbone further comprises N-heterocyclic compound bonded with the poly(arylene).

16. The ion conducting polymer of claim 1, further comprising a cross-linker compound that couples a first backbone of said ion conducting polymer and a second backbone of said ion conducting polymer.

17. The ion conducting polymer of claim 1, wherein the cross-linker comprises a poly(arylene).

18. The ion conducting polymer of claim 1, wherein the cross-linker comprises a poly(alkyl).

19. The ion conducting polymer of claim 1, wherein the cross-linker is selected from one of or multiple of the compound selected from the group consisting of: aromatic compounds, hydrocarbon compounds, aliphatic compounds and nitrogen-containing compounds.

20. An anion exchange membrane comprising:
a) the anion conducting polymer of claim 1;
b) a support layer;
wherein the anion conducting co-polymer extends through the support layer from a first side to a second side of the support layer to produce a composite anion exchange membrane; and
wherein the anion exchange membrane is a thin sheet of material having a thickness of less than 200 μm.

21. A process of casting a composite anion exchange membrane comprising:
a) providing the anion conducting co-polymer of claim 1;
b) providing a support layer having pores;
c) providing an exchange polymer solvent;
d) providing a support layer solvent having pores;
e) mixing the exchange polymer solvent and support layer solvent to produce a solvent mixture;
f) combining the solvent mixture with the anion conducting co-polymer to produce a polymer solution;
g) combining the polymer solution with the support layer such that the polymer solution enters into the pores of said support layer; and
wherein the support layer solvent wets the support layer surface; and
h) evaporating the support layer solvent and exchange polymer solvent to produce said composite anion exchange membrane wherein the anion exchange polymer extends through the pores from a first side to an opposing second side of the support layer.

22. The process of claim 21, wherein the polymer solvent is a polar solvent.

23. The process of claim 21, wherein the support layer comprises a hydrocarbon support layer or a fluoropolymer support layer.

24. The process of claim 21, wherein the support layer comprises a sulfur containing polymer or a polyetheretherketone support layer.

25. The process of claim 21, wherein combining the polymer solution includes applying pressure on the support layer and polymer solution to force the polymer solution into the pores of the support layer.
